(19) United States
(12) Patent Application Publication
(10) Pub. No.: US 2026/0175163 A1
(43) Pub. Date: Jun. 25, 2026

(54) REDUCING CONSUMPTION OF SULFIDING AGENT IN HYDROPROCESSING OF BIOFEEDSTOCKS

(71) Applicant: EXXONMOBIL TECHNOLOGY AND ENGINEERING COMPANY, Spring, TX (US)

(72) Inventors: Jenny P. SEAGRAVES, Conroe, TX (US); Michael H. RING, Conroe, TX (US); Kirtan K. TRIVEDI, Shenandoah, TX (US)

(21) Appl. No.: 19/539,480

(22) Filed: Feb. 13, 2026

Related U.S. Application Data
(63) Continuation of application No. PCT/US2024/042612, filed on Aug. 16, 2024.
(60) Provisional application No. 63/520,132, filed on Aug. 17, 2023.

(51) Int. Cl. B01D 53/18; B01D 53/047

(52) U.S. Cl. CPC B01D 53/18; B01D 53/047

(57) ABSTRACT

A variety of methods and systems are disclosed, including a method comprising contacting a first gas stream with a first absorbent, wherein the first gas stream comprises hydrogen, CO₂, and hydrogen sulfide, wherein the first absorbent provides H₂S selectivity of greater than 4 to produce at least an H₂S rich absorbent stream and a second gas stream; contacting the H₂S rich absorbent stream with a first stripping medium to produce at least an H₂S lean first absorbent and a recycle stream comprising the first stripping medium and stripped H₂S; contacting the second gas stream with a second absorbent to absorb at least a portion of the CO₂ from the second gas stream to produce a hydrogen gas stream and a CO₂ rich second absorbent; and contacting the CO₂ rich second absorbent with a second stripping medium to produce a CO₂ lean second absorbent and a CO₂ stream.

### CROSS-REFERENCE TO RELATED APPLICATIONS

This application is the U.S. National Phase of International Application No. PCT/US2024/042612, filed Aug. 16, 2024, which designates the United States and claims priority to U.S. Provisional Patent Application No. 63/520,132, filed Aug. 17, 2023. The entire disclosures of the foregoing applications are hereby incorporated by reference in their entirety for all purposes.

### FIELD

This application relates to the treatment of gas streams from hydroprocessing biofeedstocks for renewable fuel production and, more particularly, to the use of absorption techniques for selective hydrogen sulfide removal and recycling to reduce consumption of sulfiding agents.

### BACKGROUND

Renewable diesel and jet fuel is commonly produced via catalytic treatment under hydrogen, or hydroprocessing, of biofeedstocks from sustainable sources, such as used cooking oils, waste animal fats (tallow) and/or certified sustainable vegetable oils, such as rapeseed. The hydrogenation and decarboxylation of triglycerides, fatty-acid methyl esters, and free fatty acids contained in the biofeedstocks produce carbon dioxide (CO₂), carbon monoxide (CO), water, and other undesirable by-products.

One of the challenges of hydroprocessing biofeedstock is maintaining catalyst activity over time as the catalyst can be stripped of sulfide over time. The loss of catalyst activity increases reactor temperature and ultimately shortens the interval between catalyst replacement. A liquid sulfiding agent, usually in the form of dimethyl disulfide (DMDS) is added to the conversion reactors to preserve catalyst activity. The DMDS decomposes to hydrogen sulfide (H₂S) in the reactor system and exits with the effluent gas stream. This provides the sulfur required to maintain catalyst activity.

The H₂S is removed along with CO₂ by amine absorbents, typically primary, secondary, or tertiary amines, such as monoethanolamine (MEA), diethanolamine (DEA), diisopropanolamine (DIPA), 2-(2-aminoethoxy) ethanol (Diglycolamine® agent (DGA®)), or methyldiethanolamine (MDEA) in an acid gas removal unit. The acid gas is then sent to a sulfur recovery unit where the H₂S is converted to elemental sulfur for disposal.

Since biofeedstock contains little sulfur, DMDS is injected continuously to maintain catalyst activity. The amount of H₂S is typically far less than it is practical to remove with a new standalone conventional refinery sulfur recovery unit using Claus technology. Therefore, biofeedstock processing may require modification of existing equipment or the addition of new treatment units and/or sulfur recovery facilities to meet local emissions regulations.

### SUMMARY

Disclosed herein is an example method comprising: contacting a first gas stream with at least a first absorbent, wherein the first gas stream comprises hydrogen, CO₂, and hydrogen sulfide, wherein the first absorbent provides selectivity to H₂S of greater than 4 to produce at least an H₂S rich absorbent stream and a second gas stream; contacting the H₂S rich absorbent stream with at least a first stripping medium comprising hydrogen in an amount of 70 mole % to 99 mole %, wherein the first stripping medium strips 90 mole % to 99.9 mole % of absorbed hydrogen sulfide from the H₂S rich absorbent stream to produce at least an H₂S lean first absorbent and a recycle stream comprising the first stripping medium and stripped H₂S; contacting the second gas stream with at least a second absorbent to absorb at least a portion of the CO₂ from the second gas stream to produce at least a hydrogen gas stream and a CO₂ rich second absorbent; and contacting the CO₂ rich second absorbent with at least a second stripping medium to produce at least a CO₂ lean second absorbent and a CO₂ stream.

Further disclosed herein is an example method comprising reacting at least a biofeedstock and hydrogen in a hydroprocessing reactor to produce at least a hydrotreated effluent; separating the hydrotreated effluent into a first gas stream and a hydrotreated effluent comprising fuel range paraffins and water; contacting the first gas stream with at least a first absorbent, wherein the first gas stream comprises hydrogen, CO₂, and hydrogen sulfide, wherein the first absorbent has a selectivity to H₂S of 4 to 15; contacting the second gas stream with at least a second absorbent to absorb at least a portion of the CO₂ from the second gas stream to produce at least a hydrogen gas stream and a CO₂ rich second absorbent; contacting the CO₂ rich second absorbent with at least a second stripping medium to produce at least a CO₂ lean second absorbent and a CO₂ stream; contacting the H₂S rich absorbent stream with at least a portion of the hydrogen gas stream, wherein the first stripping medium strips at least 90 mole % to 99.9 mole % of absorbed hydrogen sulfide from the H₂S rich absorbent stream to produce at least an H₂S lean first absorbent and a recycle stream comprising the first stripping medium and stripped H₂S; and recycling at least a portion of the recycle stream to the hydroprocessing reactor.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is an illustration for acid gas removal and H₂S recycle in accordance with one or more embodiments.

FIG. 2 is an illustration for a contacting system for an H₂S absorber in accordance with one or more embodiments.

FIGS. 3A-3D are illustrations of droplet generators for a contacting system in accordance with one or more embodiments.

FIG. 4 is another illustration acid gas removal and H₂S recycle in accordance with one or more embodiments.

FIG. 5 is an illustration of an integrated column for use in a system for acid gas removal and recycle in accordance with one or more embodiments.

FIG. 6 is another illustration of an integrated column for use in a system for acid gas removal and H₂S recycle in accordance with one or more embodiments.

FIG. 7 is another illustration of an integrated column for use in a system for sulfur recovery and recycle in accordance with one or more embodiments.

FIG. 8 is an illustration of renewable fuel production with sulfur recovery and recycle in accordance with one or more embodiments.

FIG. 9 is an example test configuration for acid gas removal.

FIG. 10 is another example test configuration for acid gas removal.

FIG. 11 is another example test configuration for acid gas removal.

### DETAILED DESCRIPTION

Disclosed herein are techniques for acid gas removal and H₂S recycle that reduce consumption of sulfiding agents in hydroprocessing. In one or more embodiments, a gas stream from the hydroprocessing unit is selectively scrubbed with a first absorbent to remove H₂S. The absorbed H₂S can then be incorporated into a recycle gas stream with hydrogen for recycle to the hydroprocessing reactor. In addition to providing hydrogen for the hydroprocessing, the recycle gas stream also contains stripped H₂S that assists in sulfiding the hydroprocessing catalyst to maintain catalyst activity, thus reducing consumption of additional sulfiding agents.

In the hydroprocessing unit, biofeedstocks are converted by reaction with hydrogen, for example, to form normal paraffins in a transportation fuel range with removal of oxygen. As used herein, the term “fuel-range” refers to hydrocarbons with molecules including from 1 carbon to 24 carbons. It is not necessary for the hydrocarbons to contain molecules that encompass the entire range from 1 carbon to 24 carbons to be considered fuel range, but rather contain one or more molecules in the range. The fuel range hydrocarbons can be used as a renewable fuel or blended with one or more components to form a renewable fuel. Normal paraffins typically have poor cold flow properties so example embodiments further include an isomerization stage to isomerize at least a portion of the normal paraffins to branched paraffins. The isomerization stage, in some embodiments, also cracks a portion of the relatively longer hydrocarbon chain paraffins to shorter chain paraffins. An isomerization effluent including fuel-range hydrocarbons is withdrawn from the isomerization stage, wherein the fuel-range hydrocarbons include the branched paraffins.

While this process can be used to produce fuel-range hydrocarbons for renewable fuels, biofeedstocks have drawbacks for use in hydroprocessing units. As noted above, for example, the biofeedstocks, unlike petroleum-based feeds, contained little sulfur but produces undesirable by-products. This can be problematic as the sulfided form of the catalytic metal provides catalyst activity for hydroprocessing. To help maintain catalyst activity a sulfiding agent is introduced into the hydroprocessing reactor in accordance with one or more embodiments. While sulfiding agents help maintain catalyst activity, continuous injection sulfiding agent can result in significant operating costs for renewable fuel production.

To reduce the expenditures associated with sulfidation, H₂S removal, and sulfur disposal, it is desirable to capture the H₂S selectively and to recycle the H₂S along with the H₂ for reuse in the hydroprocessing reactor.

In conventional refineries, aqueous absorbents containing primary and secondary amines such as monoethanolamine (MEA), diethanolamine (DEA), diisopropanolamine (DIPA), and 2-(2-aminoethoxy) ethanol (Diglycolamine® agent (DGA®)) absorb both H₂S and CO₂ gas. Primary amines have one alkyl or aryl group bound to the nitrogen while secondary amine have two. These amines are not suitable for selective absorption of H₂S because the amines also undergo reaction with CO₂ to form carbamates. However, example embodiments use a first absorbent comprising a tertiary amine and/or a sterically hindered amine that are highly selective to H₂S. Sterically hindered amines are defined as either (i) primary amines in which the amino group is attached to a tertiary carbon or (ii) secondary amines in which the amino group is attached to at least one secondary or tertiary carbon.

Tertiary amines such as methyldiethanolamine (MDEA) lack hydrogen atom on the nitrogen and so cannot react to form a carbamate. Instead, the reaction proceeds with the formation of bicarbonate through base-catalysis mechanism. However, MDEA has limited capacity for H₂S absorption, particularly at very low partial pressures due to its low basicity. But MDEA has high selectivity because of the slow chemical reaction of CO₂ with the amine as compared to the more rapid chemical reaction of H₂S. The selectivity of an absorbent with respect to H₂S is defined as the ratio of H₂S/CO₂ in the absorbent exiting the contactor to the ratio of H₂S/CO₂ in the raw gas entering the contactor. No amine absorbent is perfectly selective. Selectivity is determined by the reaction rate of CO₂ which is temperature and partial pressure dependent, as well as by the mass transfer characteristics of the absorption equipment. Contact times must be kept relatively short and mixing of the bulk solution must be minimized to take advantage of the faster reaction of H₂S with the amine compared to the rate of CO₂ reaction.

In sterically hindered amines, the amine groups react with the H₂S to form a hydrosulfide salt in aqueous solution. Due to its high basicity, the capacity of sterically hindered amines for H₂S and CO₂ is higher than MDEA. The steric hinderance of the tertiary carbon prevent these amines from forming a stable carbamate with the CO₂, improving selectivity. Similar to MDEA, it is important to avoid excessive gas-liquid contact for selective H₂S removal.

A number of sterically hindered amine compounds have been developed for the selective removal of H₂S in the presence of CO₂ that maintains capacity even at low H₂S partial pressures. The absorbents may include an organic co-solvent to improve miscibility or to improve selectivity.

In renewable fuel production, it is necessary to treat gas mixtures containing H₂S and CO₂ to low levels. It is advantageous to remove the H₂S selectively and to recycle the captured H₂S back to the hydroprocessing reactor along with the H₂. The CO₂ is removed in the subsequent steps. Selective removal or capture of the H₂S using absorbents such as tertiary or sterically hindered amines may enable a more economical biorefining plant to be used and minimize the costs of a downstream sulfur recovery unit.

### Sulfur Recovery

In accordance with one or more embodiments, the method for recovery and recycle of H₂S includes contacting a first gas stream with at least a first absorbent, wherein the first gas stream comprises hydrogen, CO, CO₂, light hydrocarbons, water and H₂S. The first absorbent selectively absorbs hydrogen sulfide from the first gas stream to produce at least a H₂S rich absorbent stream and a second gas stream. The method further includes recovery of H₂S from the H₂S rich absorbent stream. For example, the method includes contacting the H₂S rich absorbent stream with a first stripping medium to strip absorbed hydrogen sulfide from the H₂S rich absorbent stream and thus produce at least an H₂S lean first absorbent and a recycle stream comprising the first stripping medium and stripped H₂S. At least a portion of the recycle stream can be recycled, for example, to a hydroprocessing reactor. The method further includes recovery of hydrogen from the second gas stream. For example, the method includes contacting the second gas stream with a second absorbent to absorb CO₂ from the second gas stream and thus produce at least a hydrogen gas stream and a CO₂ rich second absorbent stream. In some embodiments, at least a portion of the hydrogen rich gas stream is used as the first stripping medium. The method further includes regeneration of the CO₂ rich second absorbent. For example, the method includes contacting the CO₂ rich second absorbent with a second stripping medium to produce at least a CO₂ lean second absorbent and a CO₂ stream.

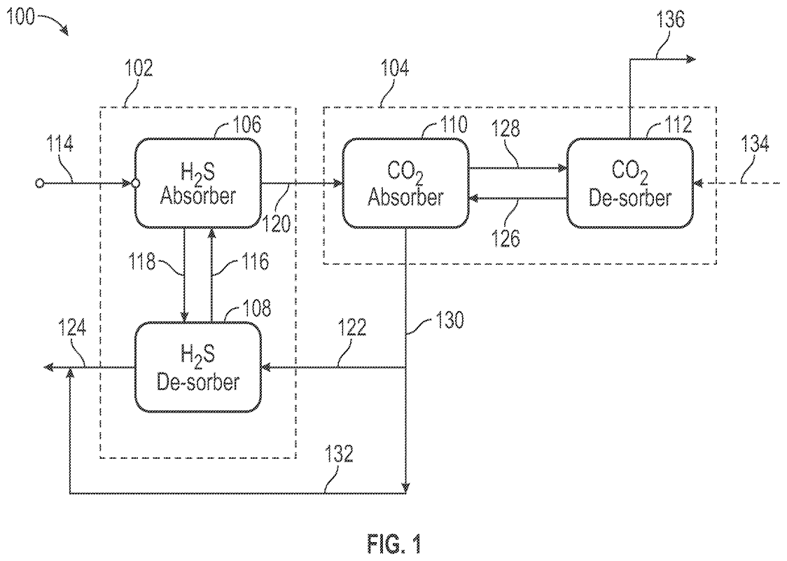

FIG. 1 shows an example of a system 100 for acid gas removal and H₂S recycle in accordance with one or more embodiments. As illustrated, the system 100 includes an H₂S section 102 and a CO₂ section 104. As illustrated, the H₂S section 102 includes an H₂S absorber 106 and an H₂S de-absorber 108. As further illustrated, the CO₂ section 104 includes a CO₂ absorber 110 and an CO₂ de-sorber 112.

In the illustrated embodiment, a first gas stream 114 is passed to the H₂S absorber 106 of the H₂S section 102. In the H₂S section 102, first gas stream 114 is contacted with at least a first absorbent 116 to selectively absorb hydrogen sulfide from the first gas stream 114 to produce at least an H₂S rich absorbent stream 118 and a second gas stream 120. The first gas stream generally comprises hydrogen, CO, CO₂, light hydrocarbons, water and H₂S. In some embodiments, the first gas stream 114 includes hydrogen in an amount of 70 mole % to 99 mol %. In some embodiments, the first gas stream 114 includes CO₂ in an amount of 0.1 mole % to 5 mole %. In some embodiments, the first gas stream 114 includes H₂S in an amount of about 5 parts per million by volume (ppmv) to 2000 ppmv. Additional components can be present in the first gas stream 114, including lighter hydrocarbons (e.g., C₁ to C₄ hydrocarbons), carbon monoxide (CO), and/or ammonia (NH₃).

The first gas stream 114 can correspond to any convenient type of hydrogen-containing stream, for example, that would be passed into a hydrogen recycle loop. In some embodiments, the first gas stream 114 can correspond to a sour hydrogen-containing stream generated from the hydroprocessing stage that performs the hydrodeoxygenation of the biofeedstock. In other embodiments, the first gas stream 114 can correspond to a stream generated from any other convenient type of hydroprocessing stage. In still other embodiments, the first gas stream 114 can correspond to a mixture of streams from various refinery processes.

As an example, after performing hydroprocessing, separation(s) are usually performed to separate desired liquid products (i.e., products that are liquid at 20° C. and 100 kPa-a) from lower boiling products. Because hydroprocessing is often performed using a substantial excess of hydrogen in the treat gas, the lower boiling products can include a substantial amount of hydrogen. Additionally, the lower boiling products can include one or more types of contaminant gases (such as CO, CO₂, H₂S, and/or NH₃), as well as some hydrocarbons in the C₁ to C₄ range. Due to the presence of the contaminant gases mixed with a substantial amount of hydrogen, such a stream of lower boiling products can be referred to as a sour hydrogen-containing stream. As an example, one option for separating liquid products from lower boiling products can be to use one or more gas-liquid separators that operate at different temperatures and/or pressures. Liquid products can be separated from lower boiling components, for example, in a high temperature, low pressure separator, although various combinations of separators at various temperatures and/or pressures could be used to generate such a stream including lower boiling components.

As previously described, the first absorbent 116 selectively absorbs H₂S from the first gas stream 114 to produce at least an H₂S rich absorbent stream 118 and a second gas stream 120. An absorption process or absorbent (e.g., first absorbent 116) is selective for H₂S if the ratio of the rates of absorption of H₂S and CO₂ is greater than the ratio of their partial pressures. The desired selectivity is achieved when the amount of H₂S is removed from the gas to the desired level, while the amount of CO₂ remaining in the gas is at an acceptable level. The selectivity of the first absorbent 116 is defined as the ratio of H₂S/CO₂ in the rich absorbent stream 118 leaving the H₂S absorber 106 to the ratio of H₂S/CO₂ in the gas stream 114 entering the H₂S absorber 106 No amine absorbent is perfectly selective. Selectivity is determined by the reaction rate of CO₂ which is temperature and partial pressure dependent, as well as the mass transfer characteristics of the absorption equipment. The range of selectivity achievable with absorbent 116 is greater than 4, and in most cases of above 10 for highly selective amines. The range of combined H₂S+CO₂ loadings is between 0.1 mol/mol to 0.8 mol/mol, wherein loading is the moles of H₂S and CO₂ absorbed divided by the mole of amines.

The first absorbent 116 may be any suitable absorbent capable of selectively absorbing H₂S from the first gas stream 114. Examples of suitable H₂S selective absorbents include tertiary amines and sterically hindered amines. These selective absorbents take advantage of the kinetic differences in the absorption reactions for CO₂ and H₂S with these amines. These amines react very quickly with H₂S but react with CO₂ relatively slowly. Combinations of suitable amines can also be used. Examples of suitable tertiary amines include methyldiethanolamine (MDEA). Triethanolamine (TEA), Tributanolamine (TBA), Diethylethanolamine (DEEA), Dimethylethanolamine (DMEA), 3-dimethylamino-1-propanol, 3-diethylamino-1-propanol, 2-diisopropylaminoethanol, and Methyldiisopropanolamine (MDIPA). In some embodiments, the sterically hindered amine has amino group that is attached to at least one secondary or tertiary carbon that is a link to an alkyl or alkoxy functional group, wherein the alkyl or alkoxy function group is methyl capped or uncapped with a terminal hydroxyl group. Specific examples of suitable sterically hindered amines include ethoxyethanol-t-butylamine (EETB), methoxyethoxyethoxyethanol-t-butylamine (MEEETB), N-[2-(2-tert-butylaminoethoxy)ethyl]-morpholine, N-[2-(3-tert-butylaminopropoxy)ethyl]-morpholine, 2-(2-tert-butylamino) propoxyethanol, 2-(2-tert-amylaminoethoxy) ethanol, 2-(2-(1-methyl-1-ethylpropylamino) ethoxy) ethanol, 2-(tert-butylamino) ethanol, 2-tert-butylamino-1-propanol, 3-tert-butylamino-1-propanol, 3-tert-butylamino-1-butanol, and 3-aza-2,2-dimethylhexane-1,6-diol. Additional examples include sterically hindered primary and secondary alkanolamines, as well as sterically hindered amino ethers. Specific examples of sterically hindered primary alkanolamines include 2-amino-2-methylpropanol (2-AMP); 2-amino-2-ethylpropanol; and 2-amino-2-propylpropanol. Examples of sterically hindered amino ethers include 1,2-bis(tert-butylaminoethoxy) ethane, bis(tert-butylaminoethyl) ether; and mixtures thereof. Examples of sterically hindered secondary alkanolamines include 2-(2-tert-butylaminoethoxy) ethanol and 2-N-methylamino-2-methylpropan-1-ol.

One example of a sterically hindered amine suitable for use as the first absorbent 116 is provided by formula 1 below:

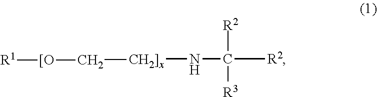

wherein R¹ is a C1-C5 alkyl or a C1-C5 alkyl alcohol, R² is a C1-C5 alkyl, R³ is hydrogen or a C1-C5 alkyl and x is an integer from 1 to 10.

Another example of a sterically hindered amine suitable for use as the first absorbent 116 is provided by formula 2 below:

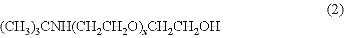

wherein x is an integer from 1 to 4.

Another example of a sterically hindered amine suitable for use as the first absorbent 116 is provided by formula 3 below:

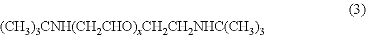

wherein x is an integer from 1 to 4.

In addition to the amine, the first absorbent 116 may also include an organic co-solvent, in accordance with one or more embodiments. In contrast to a chemical solvent such as the preceding amines that rely on a chemical reaction for H₂S absorption, organic co-solvents remove the H₂S without chemical reactions. Examples of suitable organic co-solvents include sulfones, polyethylene glycol, polyethylene glycol di- or mono-ethers, and combinations thereof. Examples of specific co-solvents include sulfolane, triethylene glycol, and triethylene glycol monomethylether. The presence of the organic co-solvents can improve the miscibility of the sterically hindered amines, as well as improve selectivity, for example, where the primary solvent is an aqueous solvent. Where used, the organic co-solvent is included in the first absorbent 116 in an amount of up to 30 wt % in solution, for example, 5 wt % to 30 wt %. The amine or amine mixture is in the amount of 5 wt % to 50 wt % and water 20 wt % to 95 wt %.

The H₂S absorber 106 uses any suitable type of contactor to facilitate contact between the first gas stream 114 and the first absorbent 116 for selective H₂S removal. Since the selectivity of the first absorbent 116 is based on differing reaction rates, the residence time in the H₂S absorber 106 can be selected to maximize H₂S uptake while minimizing the time allowed for the CO₂ reaction. Examples of suitable contactors include spray columns, trayed columns, and in-line contacting systems that use a co-current contactor with a droplet generator.

The conditions for the H₂S absorber 106 include any suitable conditions to facilitate contact between the first gas stream 114 and the first absorbent 116 for selective H₂S removal. Examples of suitable conditions include a temperature of 15° C. to 80° C. and a pressure of 1380 kPa to about 10300 kPa (e.g., 2750 kPa to 6200 kPa).

In the illustrated embodiment, the H₂S section further includes an H₂S de-sorber 108 that receives the H₂S rich absorbent stream 118 from the H₂S absorber. H₂S de-sorber 108 regenerates the H₂S rich absorbent stream 118 by recovery of the absorbed H₂S. In some embodiments, the H₂S rich absorbent stream 118 is contacted with a hydrogen stripping medium 122 in the H₂S desorber 108 to produce at least an H₂S lean first absorbent 116 and a recycle stream 124 comprising hydrogen and stripped H₂S. Thus, the absorbed H₂S is transferred directly from the liquid absorbent into the stripping gas. The H₂S lean first absorbent can then be used, for example, as the first absorbent 116 to contact the first gas stream 114.

The hydrogen stripping medium 122 includes hydrogen. For example, the hydrogen stripping medium 122 includes hydrogen in an amount of 70 mole % or more, for example, 70 mole % to 99 mole % or 90 mole % to 99 mole %. The hydrogen stripping medium 122 can be from any suitable source, including makeup hydrogen or hydrogen recovered from the first gas stream 114, for example, in the CO₂ section 104. The hydrogen stripping medium 122, in addition to hydrogen, further includes CO₂ in one or more embodiments. For example, the hydrogen stripping medium 122 has a CO₂ concentration of 1,000 ppmv, 500 ppmv, 100 ppmv, 50 ppm, 10 ppmv or less in accordance with one or more embodiments. In some embodiments, the hydrogen stripping medium 122 has a CO₂ concentration of 10 ppmv to 1,000 ppmv.

To aid in the release of H₂S in the H₂S de-sorber 108, the hydrogen stripping medium 122 and/or the H₂S rich absorbent stream 118 are heated in some embodiments. For example, the stripping medium 122 and/or the H₂S rich absorbent stream 118 are heated to a temperature of 80° C. to 150° C. In general, the stripping medium 122 and/or the H₂S rich absorbent stream 118 should be heated to a temperature less than the boiling point of the first absorbent 116. The heat is supplied from any suitable source, including from external heat or heat integration from the process.

The recycle stream 124 from the H₂S de-sorber 108 includes the stripped H₂S and hydrogen from the hydrogen stripping medium 122. For example, the recycle stream 124 has a hydrogen concentration of >80 mole % and an H₂S concentration of <1000 ppmv. For example, the recycle stream can have a hydrogen concentration of 80 mole % to 95 mole % and an H₂S of 50 ppmv to 1000 ppmv. The recycle stream 124 also contains small concentrations of CO₂ in accordance with one or more embodiments. Accordingly, H₂S entering the system 100 is recovered and recycled. In some embodiments, at least 90 mole % of the H₂S entering the system 100 is recovered in the recycle stream 124, for example from 90 mole % to 99 mole % of the H₂S entering the system 100 may be recovered in the recycle stream 124. By recovering the H₂S and recycling the H₂S, for example, to a hydrogenation reactor, the use of external sulfiding agents can be reduced. In addition, by recovery of the H₂S into hydrogen, further conversion to elemental sulfur in the sulfur recovery unit for disposal is decreased or eliminated. Also, the need for recompression and transfer of concentrated and toxic H₂S is avoided, in accordance with one or more embodiments.

In the illustrated embodiment, the second gas stream 120 from the H₂S absorber 106 is passed to the CO₂ absorber 110 of the CO₂ section 104. The second gas stream 120 includes, for example, hydrogen, CO, C₁ to C₄ hydrocarbons, and CO₂ that was not absorbed in the H₂S section 104. The second gas stream 120 can also include other contaminants from the first gas stream 114, such as CO and C₁ to C₄ hydrocarbons. In the CO₂ section 104, the second gas stream 120 is contacted with at least a second absorbent 126 to absorb CO₂ from the second gas stream 120 to produce at least a CO₂ rich absorbent stream 128 and a hydrogen gas stream 130. At least a portion of the hydrogen gas stream 130 is used as the hydrogen stripping medium 122 in the H₂S de-sorber 108 in accordance with one or more embodiments. As illustrated, a portion of the hydrogen gas stream 130 is directed to the H₂S de-sorber 108 for use as the hydrogen stripping medium 122. In some embodiments, the remaining portion 132 of the hydrogen gas stream 130 is added to the recycle stream 124 from the H₂S de-sorber 108.

In accordance with present embodiments, the second absorbent 126 should absorb as much CO₂ as possible from the second gas stream 120, for example, at least 90 mole %. In some embodiments, the second absorbent 126 absorbs 90 mole % to 99.8 mole % or 95 mole % to 99.8 mole % of the CO₂ from the second gas stream 120. In some embodiments, the hydrogen gas stream 130 has a CO₂ concentration of 1000 ppmv or less, for example, a CO₂ concentration of 1 ppmv to 1000 ppmv.

The second absorbent 126 may be any suitable absorbent capable of absorbing CO₂ from the second gas stream 120. Examples of suitable CO₂ absorbents suitable for use as the second absorbent 126 include a primary alkanolamine, a secondary alkanolamine, or a sterically hindered amine. Combinations of CO₂ absorbents can also be used. Alkanolamines are chemical compounds that include both hydroxyl and amino functional groups on an alkane backbone. Specific examples of suitable CO₂ absorbents include monoethanolamine (MEA), diethanolamine (DEA), 2-(2-aminoethoxy) ethanol (Diglycolamine® agent (DGA®)), 2-amino-1-propanol (AMP), 2-piperadine ethanol (2-PE), or piperazine. In some embodiments, the CO₂ absorbent 126 includes a tertiary alkanolamine, such as methyldiethanolamine (MDEA), blended with a primary or secondary alkanolamine, or a sterically hindered amine.

In addition to the amine, the second absorbent 126 also includes an organic co-solvent, in accordance with one or more embodiments. In contrast to a chemical solvent such as the preceding amines that rely on a chemical reaction for CO₂ absorption, organic co-solvents remove the CO₂ without chemical reactions. Examples of suitable organic co-solvents include sulfones, polyethylene glycol, polyethylene glycol di- or mono-ethers, and combinations thereof. Examples of specific co-solvents include sulfolane, triethylene glycol, and triethylene glycol monomethylether. Where used, the organic co-solvent is included in the second absorbent 126 in an amount of up to 30 wt %, for example, 5 wt % to 30 wt %.

The CO₂ absorber 110 uses any suitable type of contactor to facilitate contact between the second gas stream 120 and the second absorbent 126 for CO₂ removal. Examples of suitable contactors include trayed, packed columns, or rotating packed beds.

The conditions for the CO₂ absorber 110 include any suitable conditions to facilitate contact between the second gas stream 120 and the second absorbent 126 for CO₂ removal. Examples of suitable conditions include a temperature of 15° C. to 80° C. or and a pressure of 1380 kPA to 10300 kPa or 2700 kPa to 6200 kPa.

In the illustrated embodiment, the CO₂ section 104 further includes a CO₂ de-sorber 112 that receives the CO₂ rich absorbent stream 128 from the CO₂ absorber 110. The CO₂ rich absorbent stream 128 includes absorbed CO₂ from the second gas stream 120. The CO₂ de-sorber 112 regenerates the CO₂ rich absorbent stream 128 by recovery of the absorbed CO₂. In some embodiments, the CO₂ rich absorbent stream 128 is stripped with stream 134. Any suitable source of the stream 134 is used, including, for example, direct injection of steam or a reboiler that uses steam as the heat source or the heat could be provided from the process. For example, the CO₂ rich absorbent stream 128 is contacted by stripping steam generated by the reboiler in the CO₂ de-sorber 112 to produce at least a CO₂ lean second absorbent and a CO₂ stream 136 comprising of the steam and stripped CO₂. The CO₂ lean second absorbent can then be used, for example, as the second absorbent 126 to contact the second gas stream 120. In some embodiments, the CO₂ stream 136 can be sent to disposal or sequestration.

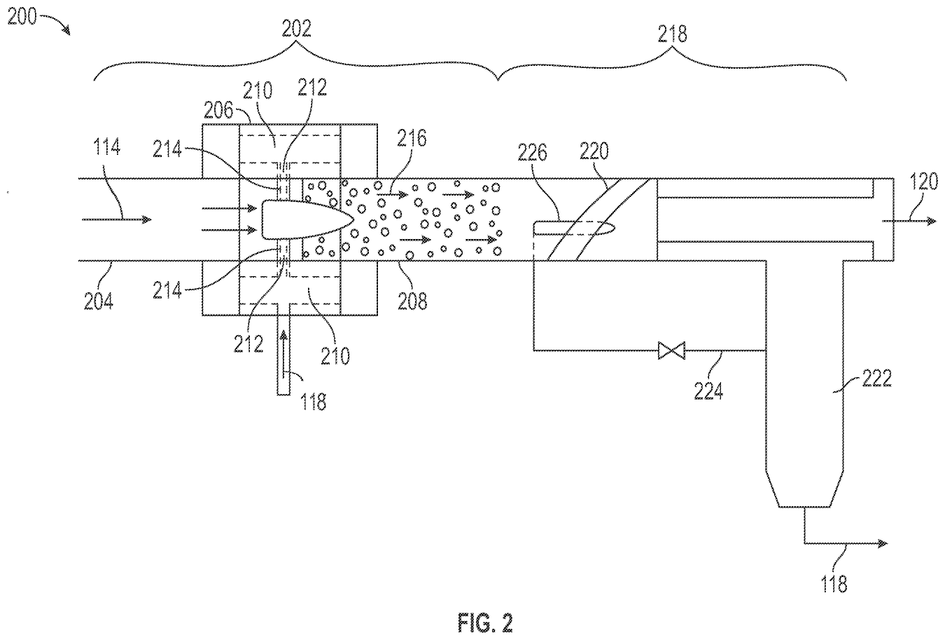

FIG. 2 is an illustration for an in-line contacting system 200 for an H₂S absorber in accordance with one or more embodiments. The in-line contacting system 200 can provide for the separation of components within a gas stream, such as separation of H₂S from first gas stream 114. The in-line contacting system 200 includes a co-current contactor 202 that is positioned in-line within a pipe 204. The co-current contactor 202 may include a number of components that provide for the efficient contacting of a liquid droplet stream, such as first absorbent 116 with a flowing gas stream such as first gas stream 114, for the separation of H₂S from the first gas stream 114. In some embodiments, more than one contacting system 100 may be used in series, parallel, and/or countercurrent with one another.

The co-current contactor 202 may include a droplet generator 206 and a mass transfer section 208. As shown in FIG. 2, the first gas stream 114 may be flowed through the pipe 204 and into the droplet generator 206. The first absorbent 116 may also be flowed into the droplet generator 206, for example, through a hollow space 210 coupled to flow channels 212 in the droplet generator 206.

From the flow channels 212, first absorbent 116 is released into the first gas stream 114 as fine droplets through injection orifices 214 and is then flowed into the mass transfer section 208. This can result in the generation of a treated gas stream 216 within the mass transfer section 208. The treated gas stream 216 may include small liquid droplets dispersed in a gas phase. For H₂S separation processes, the liquid droplets may include H₂S molecules from the first gas stream 114 that are absorbed or dissolved into the first absorbent 116.

The treated gas stream 216 may be flowed from the mass transfer section 208 to a separation system 218, which includes a cyclonic separator 220 and a collector 222. Alternatively, the separation system 218 may include a mesh screen or a settling vessel. However, in-line cyclonic separators may be used to realize the benefits of compactness and reduced diameter. The cyclonic separator 220 removes the liquid droplets from the gas phase. The liquid droplets, which as previously stated may include H₂S absorbed or dissolved into the first absorbent 116, are diverted into collector 222, which directs the collected liquids as a rich first absorbent stream 118 to a regenerator (e.g., H₂S de-sorber 108 on FIG. 1). A pressure equalization line 224 may extend from the collector 222 and operates to allow gas in the collector to return to the separation system 218. In some embodiments, this gas flows via a nozzle 226 or eductor situated inside the separation system 218. A second gas stream 120, from which the H₂S and rich solvent has been separated, exits the separation system 218 in an in-line orientation with the pipe 204. The amount of H₂S in second gas stream 120, as measured in weight percentage, is lower than the amount of H₂S in first gas stream 114.

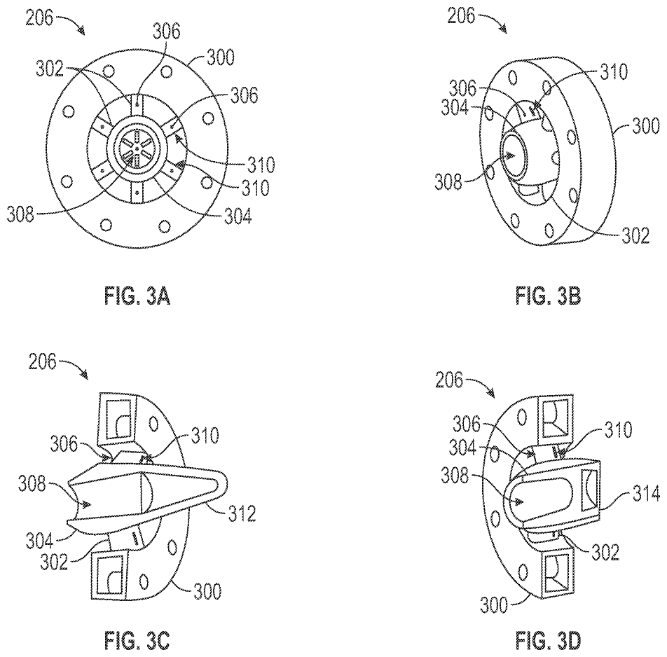

FIG. 3A is a front view of droplet generator 206 according to one or more embodiments. The droplet generator 206 is a contacting device that may be implemented within a co-current contactor, for example, in the co-current contactor 202 described with respect to the inline contacting system 200 of FIG. 2. The front view of the droplet generator 206 represents an upstream view of the droplet generator 206.

The droplet generator 206 may include an annular support ring 300, a number of spokes 302 extending from the outer annular support ring 300 and a gas entry cone 304. The annular support ring 300 may secure the droplet generator 206 in-line within the pipe (e.g., pipe 204 on FIG. 2). In addition, the spokes 302 may provide support for the gas entry cone 304.

The outer annular support ring 300 may be designed as a flanged connection, or as a removable or fixed sleeve inside the pipe. In addition, the annular support ring 300 may include a liquid feed system and a hollow channel described further with respect to FIGS. 3C and 3D. A liquid stream, such as, a first absorbent 116 (e.g., shown on FIGS. 1 and 2), may be fed to the droplet generator 206 via the hollow channel in the annular support ring 300. The hollow channel may allow equal distribution of the liquid stream along the perimeter of the droplet generator 206.

Small liquid channels within the annular support ring 300 may provide a flow path for the first absorbent 116 to flow through liquid injection orifices 306 within the spokes 302. The liquid injection orifices 306 may be located on or near the leading edge of each spoke 302. Placement of the liquid injection orifices 306 on the spokes 302 may allow the lean solvent stream to be uniformly distributed in a gas stream that is directed between the spokes 302. Specifically, the first absorbent 116 may be contacted by the portion of the first gas stream 114 flowing through the gaps between the spokes 302 and can be sheared into small droplets and entrained in the gas phase.

A portion of the first gas stream 114 flows between the spokes 302 to the mass transfer section while the remainder of the gas stream flows into the gas entry cone 304 through a gas inlet 308. The gas entry cone 304 may block a cross-sectional portion of the pipe. The spokes 302 include gas exit slots 310 that allow the gas stream to be flowed out of the gas entry cone 304. This may increase the velocity of the gas stream as it flows through the pipe. The gas entry cone 304 may direct a predetermined amount of the gas stream to the gas exit slots 310 on the spokes 302.

Some of the first absorbent 116 injected through the spokes 302 may be deposited on the surface of the spokes 302 as a liquid film. As the first gas stream 114 flows through the gas entry cone 304 and is directed out of the gas exit slots 310 on the spokes 302, the first gas stream 114 may sweep, or blow, much of the liquid film off the surface of the spokes 302. This may enhance the dispersion of the first absorbent 116 into the gas phase. Further, the obstruction to the flow of the first gas stream 114 and the shearing effect created by the exit of the first gas stream 114 through the gas exit slots 310 may provide a zone with an increased turbulent dissipation rate. This may result in the generation of smaller droplets that enhance the mass transfer rate between the first absorbent 116 and the first gas stream 114.

The dimensions of various components of the droplet generator 206 may be varied such that the first gas stream 114 flows at a high velocity. This may be accomplished via either a sudden reduction in the diameter of the annular support ring 300 or a gradual reduction in the diameter of the annular support ring 300. The outer wall of the droplet generator 206 may be slightly converging in shape, terminating at the point where the first gas stream 114 and the first absorbent 116 are discharged into the downstream pipe. This can allow for the shearing and re-entrainment of any solvent film that is removed from the droplet generator 206. Further, a radial inward ring, grooved surface, or other suitable equipment may be included on the outer diameter of the droplet generator 206 near the point where the natural gas stream and the lean solvent stream are discharged into the downstream pipe. This may enhance the degree of liquid entrainment within the gas phase.

The downstream end of the droplet generator 206 may discharge into a section of pipe, which can be a straight section of pipe, or a concentrically expanding section of pipe. The gas entry cone 304 may terminate with a blunt ended cone or a tapered ended cone. In other embodiments, the gas entry cone 304 can terminate with a ridged cone, which can include multiple concentric ridges along the cone that provide multiple locations for droplet generation. In addition, any number of gas exit slots 310 may be provided on the cone itself to allow for the removal of solvent film from the droplet generator 206.

FIG. 3B is a side perspective view of the droplet generator 206. Like numbered items are as described with respect to FIG. 3A. As shown in FIG. 3B, the upstream portion of the gas entry cone 304 may extend further into the pipe than the annular support ring 300 and the spokes 302 in the upstream direction. The downstream portion of the gas entry cone 304 can also extend further into the pipe than the annular support ring 300 and the spokes 302 in the downstream direction. The length of the gas entry cone 304 in the downstream direction depends on the type of cone at the end of the gas entry cone 304, as described further with respect to FIGS. 3C and 3D.

FIG. 3C is a cross-sectional side perspective view of the droplet generator 206 according to a disclosed aspect. Like numbered items are as described with respect to FIGS. 3A and 3B. According to FIG. 3C, the gas entry cone 304 of the droplet generator 206 terminates with a tapered ended cone 312. Terminating the gas entry cone 304 with a tapered ended cone 312 may reduce the overall pressure drop in the pipe caused by the droplet generator 206.

FIG. 3D is a cross-sectional side perspective view of the droplet generator 206 according to another embodiment. Like numbered items are as described with respect to FIGS. 3A-3C. According to FIG. 3D, the gas entry cone 304 of the droplet generator 206 terminates with a blunt ended cone 314. Terminating the gas entry cone 304 with a blunt ended cone 314 may encourage droplet formation in the center of the pipe.

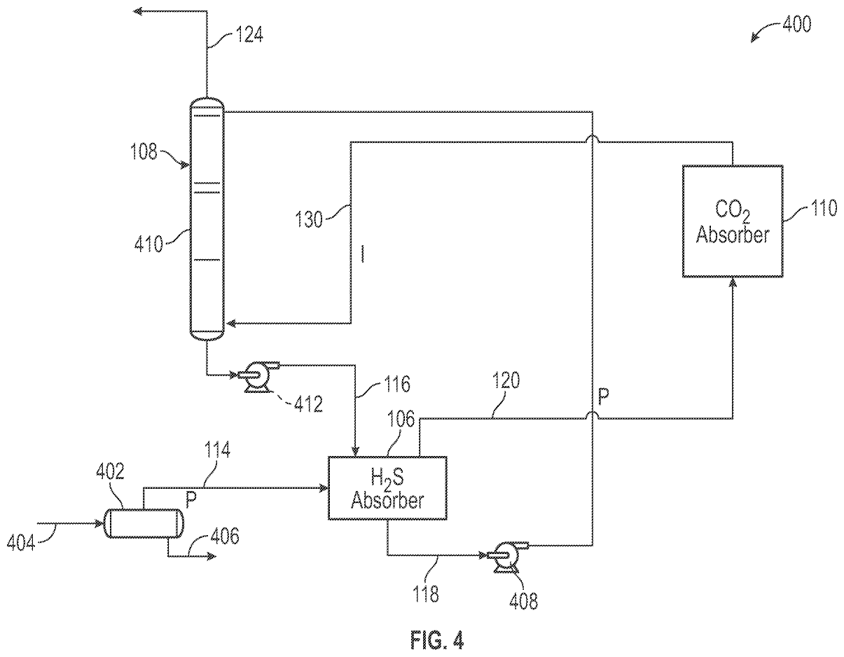

FIG. 4 is an illustration of another system 400 for sulfur recovery and recycle in accordance with one or more embodiments. In the illustrated embodiment, a first gas stream 114 is introduced into an H₂S absorber 106. As previously described, the first gas stream 114 includes hydrogen, H₂S, CO, water, C₁ to C₄ hydrocarbons and CO₂ in one or more embodiments. In the illustrated embodiment, the first gas stream 114 is received from a separator 402. The separator 402 receives a gas or gas and liquid stream 404 that is separated into a gas phase and a liquid phase. Stream 404 is typically, for example, the cooled hydrotreater reactor effluent. In some embodiments, the separator is a high pressure, low temperature separator, for example, operating at 15° C. to 80° C. and 1300 kPa to 10300 kPa. The gas phase is withdrawn as the first gas stream 114 while the liquid phase is withdrawn as separated liquid 406. The gas stream 404 can correspond to any convenient type of hydrogen-containing stream, for example, that would be passed into a hydrogen recycle loop. In some embodiments, the gas stream 404 can correspond to a sour hydrogen-containing stream generated from the hydroprocessing stage that performs the hydrodeoxygenation of the biofeedstock. In other embodiments, the gas stream 404 can also include a stream corresponding to a stream generated from any other convenient type of hydroprocessing stage. In still other embodiments, the first gas stream can correspond to a mixture of streams from various refinery processes.

In the H₂S absorber 106, the first gas stream 114 contacts at least a first absorbent 116 that selectively absorbs H₂S from the first gas stream 114 to produce at least an H₂S rich absorbent stream 118 and a second gas stream 120. The second gas stream 120 is fed to a CO₂ absorber 110 for recovery of hydrogen by removal of CO₂ to form a hydrogen gas stream 130. For simplicity, the second absorbent (e.g., second absorbent 126 on FIG. 1) and corresponding CO₂ regeneration (CO₂ de-sorber 112 on FIG. 1) are not illustrated on FIG. 4. H₂S rich absorbent stream 118 is pumped by way of first pump 408 to the H₂S de-sorber 108. In the illustrated embodiment, the H₂S de-sorber 108 includes a stripper column 410. In the illustrated embodiment, the stripper column 410 further receives the hydrogen gas stream 130 as a stripping medium. As previously described, at least a portion of the hydrogen gas stream 130 can bypass the stripper column 410 such that only a portion of the hydrogen gas stream 130 is fed into the stripper column 410. Both streams 130 and 118 may be optionally heated. In the stripper column 410, the hydrogen gas stream 130 countercurrently contacts the H₂S rich absorbent stream 118 to remove the absorbed H₂S forming a recycle stream 124 and an H₂S lean absorbent stream 116. As illustrated, the H₂S lean absorbent stream 116 is pumped as first absorbent 116 by way of second pump 412 to the H₂S absorber 106. As previously, described, the recycle stream 124 comprises hydrogen and stripped H₂S can be recycled, for example, to a hydroprocessing reactor. In this manner, system 400 provides for the removal and reuse of H₂S.

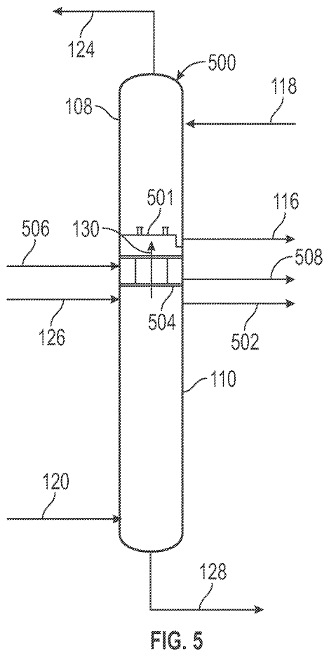

FIG. 5 is an illustration of an integrated column 500 for use in acid gas removal and H₂S recycle in accordance with one or more embodiments. The integrated column 500 may be used, for example, in the system 100 of FIG. 1 or the system 400 of FIG. 4 to integrate one or more components into the integrated column 500. In the illustrated embodiment, the integrated column 500 includes an H₂S de-sorber 108 and a CO₂ absorber 110. As illustrated, the H₂S de-sorber 108 may be positioned above the CO₂ absorber 110. One or more trays 501 may be positioned between the H₂S de-sorber 108 and a CO₂ absorber 110, for example, to segregate the units preventing liquid downflow while allowing gas flow from the CO₂ absorber 110 to the H₂S de-sorber 108.

In the illustrated embodiment, the second gas stream 120 enters the CO₂ absorber 110. As previously discussed, the second gas stream 120 is produced in the H₂S absorber 106, as shown on FIG. 1 or FIG. 4, and includes hydrogen and CO₂. The CO₂ absorber 110 also receives a second absorbent 126. In the CO₂ absorber 110, the second gas stream 120 contacts at least the second absorbent 126 to absorb CO₂ from the second gas stream 120. In the illustrated embodiment, the second gas stream 120 countercurrently contacts the second absorbent 126 as the second gas stream 120 rises in the H₂S absorber 108. A portion of the CO₂ stripped gas is removed from the CO₂ absorber 110 as purge stream 502. The rate of stream 502 is decided by the CO allowable concentration at the reactor inlet. Another portion of the CO₂ stripped gas (e.g., hydrogen gas stream 130) is internally or externally heated by a heating medium in a heat exchanger, such as internal heat exchanger 504. In the illustrated embodiment, the internal heat exchanger, receives heating medium feed 506 that exits by way of heating medium outlet stream 508. A CO₂ rich absorbent stream 128 is also removed from the CO₂ absorber 110 and can be routed to a regenerator (e.g., CO₂ de-sorber 112 on FIG. 1).

In the illustrated embodiment, the hydrogen gas stream 130 heated by the internal heat exchanger 504 is passed to the H₂S de-sorber 108. As previously discussed, hydrogen gas stream 130 is predominately hydrogen with small amounts of other components, such as CO₂. The H₂S de-sorber 108 also receives an H₂S rich absorbent stream 118 from the H₂S absorber 106 (e.g., FIG. 1 or FIG. 4). In the H₂S de-sorber 108, the hydrogen gas stream 130 contacts (e.g., countercurrently) the H₂S rich absorbent stream 118 to remove the absorbed H₂S forming a recycle stream 124 and an H₂S lean absorbent stream. The H₂S lean absorbent stream may be removed from the H₂S de-sorber 108 and routed to the H₂S absorber 106 as first absorbent 116, as shown on FIG. 1 or FIG. 4. The recycle stream 124 comprising hydrogen and stripped H₂S is also removed from the H₂S de-sorber 108 and can be recycled, for example, to a hydroprocessing reactor.

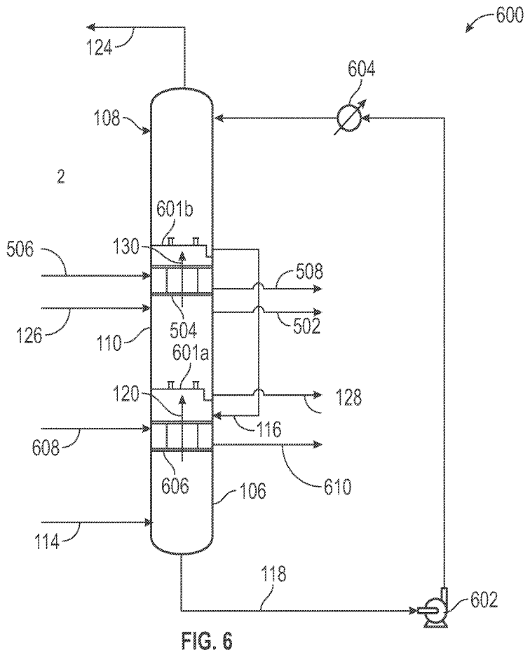

FIG. 6 is another illustration of an integrated column 600 for use in acid gas removal and H₂S recycle in accordance with one or more embodiments. The integrated column 600 may be used, for example, in the system 100 of FIG. 1 or the system 400 of FIG. 4 to integrate one or more components into the integrated column 600. In the illustrated embodiment, the integrated column 600 includes an H₂S absorber 106, an H₂S de-sorber 108 and a CO₂ absorber 110. As illustrated, the CO₂ absorber 110 may be positioned between the H₂S absorber 106 and the H₂S de-sorber 108. One or more trays 601a, 601b may be positioned between the H₂S absorber 106 and the CO₂ absorber 110 and between the H₂S de-sorber 108 and the CO₂ absorber 110, respectively, for example, to prevent liquid downflow while allowing gas upflow.

In the illustrated embodiment, the H₂S absorber 106 receives a first gas stream 114 and a first absorbent 116. As previously discussed, the first gas stream 114 includes hydrogen, H₂S, and CO₂. In the H₂S absorber 106, the first gas stream 114 contacts (e.g., countercurrently) at least the first absorbent 116 that selectively absorbs H₂S from the first gas stream 114 to produce at least an H₂S rich absorbent stream 118 and a second gas stream 120. The H₂S rich absorbent stream 118 is removed from the H₂S absorber 106 and pumped by first pump 602 through heat exchanger 604 to the H₂S de-sorber 108. The second gas stream 120 is internally or externally cooled by a heat exchanger, such as first internal heat exchanger 606. The first internal heat exchanger 606 receives a cooling medium feed 608 that exits as cooling medium outlet stream 610 after heat exchange with the second gas stream 120.

In the illustrated embodiment, the second gas stream 120 rises in the integrated column 600 and into the CO₂ absorber 110. As previously discussed, the second gas stream 120 includes hydrogen and CO₂. The CO₂ absorber 110 also receives a second absorbent 126. In the CO₂ absorber 110, the second gas stream 120 contacts at least the second absorbent 126 to absorb CO₂ from the second gas stream 120. In the illustrated embodiment, the second gas stream 120 countercurrently contacts the second absorbent 126 as the second gas stream 120 rises in the CO₂ absorber 110. A portion of the CO₂ stripped gas is removed from the CO₂ absorber 110 as purge stream 502. The rate of stream 502 is determined based on the allowable concentration of CO at the reactor inlet. Another portion of the CO₂ stripped gas (e.g., hydrogen gas stream 130) is internally or externally heated by a heating medium in a heat exchanger, such as internal heat exchanger 504. In the illustrated embodiment, the internal heat exchanger, receives heating medium feed 506 that exits by way of heating medium outlet stream 508. A CO₂ rich absorbent stream 128 is also removed from the CO₂ absorber 110 and can be routed to a regenerator (e.g., CO₂ de-sorber 112 on FIG. 1).

In the illustrated embodiment, the hydrogen gas stream 130 heated by the internal heat exchanger 504 is passed to the H₂S de-sorber 108. As previously discussed, hydrogen gas stream 130 is predominately hydrogen with small amounts of other components, such as CO₂. The H₂S de-sorber 108 also receives an H₂S rich absorbent stream 118 from the H₂S absorber 106. In the H₂S de-sorber 108, the hydrogen gas stream 130 contacts (e.g., countercurrently) the H₂S rich absorbent stream 118 to remove the absorbed H₂S forming a recycle stream 124 and an H₂S lean absorbent stream. The H₂S lean absorbent stream may be removed from the H₂S de-sorber 108 and routed to the H₂S absorber 106 as first absorbent 116. The recycle stream 124 comprising hydrogen and stripped H₂S is also removed from the H₂S de-sorber 108 and can be recycled, for example, to a hydroprocessing reactor.

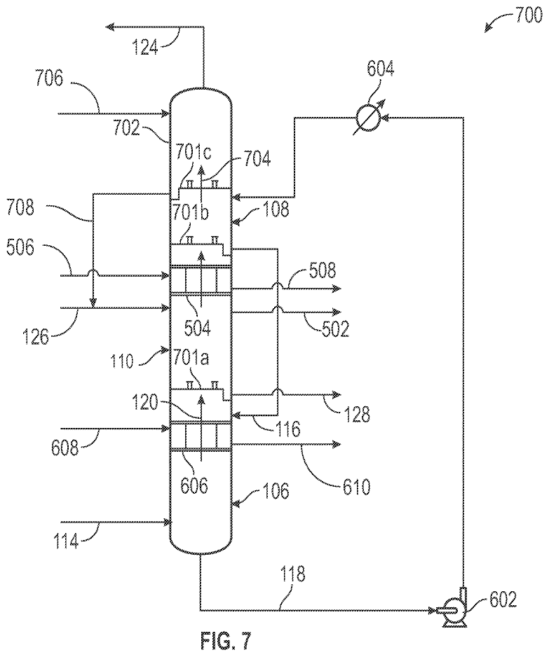

FIG. 7 is another illustration of an integrated column 700 for acid gas removal and H₂S recycle in accordance with one or more embodiments. The integrated column 700 may be used, for example, in the system 100 of FIG. 1 or the system 400 of FIG. 4 to integrate one or more components into the integrated column 700. In the illustrated embodiment, the integrated column 700 includes an H₂S absorber 106, an H₂S de-sorber 108 and a CO₂ absorber 110. In addition, the integrated column 700 further includes a supplemental H₂S de-sorber section 702. As illustrated, the CO₂ absorber 110 may be positioned between the H₂S absorber 106 and the H₂S de-sorber 108. In addition, the H₂S de-sorber 108 may be positioned above the CO₂ absorber 110 with the supplemental H₂S de-sorber section 702 positioned above the H₂S de-sorber 108. One or more trays 701a, 701b, 701c may be positioned between the H₂S absorber 106 and the CO₂ absorber 110, between the H₂S de-sorber 108 and the CO₂ absorber 110, and between the H₂S de-sorber 108 and supplemental H₂S de-sorber section 702, respectively, for example, to prevent liquid downflow while allowing gas upflow.

In the illustrated embodiment, the H₂S absorber 106 receives a first gas stream 114 and a first absorbent 116. As previously discussed, the first gas stream 114 includes hydrogen, H₂S, and CO₂. In the H₂S absorber 106, the first gas stream 114 contacts (e.g., countercurrently) at least the first absorbent 116 that selectively absorbs H₂S from the first gas stream 114 to produce at least an H₂S rich absorbent stream 118 and a second gas stream 120. The H₂S rich absorbent stream 118 is removed from the H₂S absorber 106 and pumped by first pump 602 through heat exchanger 604 to the H₂S de-sorber 108. The second gas stream 120 is internally or externally cooled by a heat exchanger, such as first internal heat exchanger 606. The first internal heat exchanger 606 receives a cooling medium feed 608 that exits as cooling medium outlet stream 610 after heat exchange with the second gas stream 120.

In the illustrated embodiment, the second gas stream 120 rises in the integrated column 700 and into the CO₂ absorber 110. As previously discussed, the second gas stream 120 includes hydrogen and CO₂. The CO₂ absorber 110 also receives a second absorbent 126. In the CO₂ absorber 110, the second gas stream 120 contacts at least the second absorbent 126 to absorb CO₂ from the second gas stream 120. In the illustrated embodiment, the second gas stream 120 countercurrently contacts the second absorbent 126 as the second gas stream 120 rises in the H₂S absorber 108. A portion of the CO₂ stripped gas is removed from the CO₂ absorber 110 as purge stream 502. The rate of stream 502 is determined based on the allowable concentration of CO at the reactor inlet. Another portion of the CO₂ stripped gas (e.g., hydrogen gas stream 130) is internally or externally heated by a heating medium in a heat exchanger, such as internal heat exchanger 504. In the illustrated embodiment, the internal heat exchanger, receives heating medium feed 506 that exits by way of heating medium outlet stream 508. A CO₂ rich absorbent stream 128 is also removed from the CO₂ absorber 110 and can be routed to a regenerator (e.g., CO₂ de-sorber 112 on FIG. 1)

In the illustrated embodiment, the hydrogen gas stream 130 heated by the internal heat exchanger 504 is passed to the H₂S de-sorber 108. As previously discussed, hydrogen gas stream 130 is predominately hydrogen with small amounts of other components, such as CO₂. The H₂S de-sorber 108 also receives an H₂S rich absorbent stream 118 from the H₂S absorber 106. In the H₂S de-sorber 108, the hydrogen gas stream 130 contacts (e.g., countercurrently) the H₂S rich absorbent stream 118 to remove the absorbed H₂S forming a H₂S stripped gas stream 704 and an H₂S lean absorbent stream. The H₂S lean absorbent stream may be removed from the H₂S de-sorber 108 and routed to the H₂S absorber 106 as first absorbent 116.

In the illustrated embodiment, the supplemental H₂S de-sorber section 702 receives a rich amine stream 706 that includes an amine absorbent and absorbed H₂S. The rich amine stream 706 can be from any suitable source of H₂S-containing amine, such as another amine unit. In some embodiments, the rich amine stream 706 is obtained from another process unit at the same refinery site. The supplemental H₂S de-sorber section 702 also receives the H₂S stripped gas stream 704 from the H₂S de-sorber 108. In the supplemental H₂S de-sorber section 702, the rich amine stream 706 contacts (e.g., countercurrently) the H₂S stripped gas stream 704 to remove the absorbed H₂S forming a recycle stream 124 and an H₂S lean amine stream 708. The H₂S lean amine stream 708 may be removed from the supplemental H₂S de-sorber section 702 and added to the second absorbent 126, which is then fed into the CO₂ absorber 110. In some embodiments, the H₂S lean amine stream 708 may alternative be combined the CO₂ rich absorbent stream 128 removed from the CO₂ absorber 110. The recycle stream 124 comprising hydrogen and stripped H₂S is also removed from the supplemental H₂S de-sorber section 702 and can be recycled, for example, to a hydroprocessing reactor. Because the recycle stream 124 picks up additional H₂S in the supplemental H₂S de-sorber section 702, the recycle stream 124 contains an increased level of H₂S, thus potentially limiting the need for additional sulfiding agents in the hydroprocessing reactor.

FIGS. 5-7 illustrate various embodiments that integrate one or more sections for recovery and recycle of H₂S. In each embodiment, the various sections are stacked forming the integrated column, such as integrated column 500 on FIG. 5, integrated column 600 on FIG. 6, and integrated column 700 on FIG. 7. To reduce column height, in accordance with one or more embodiments, the sections can be enclosed in a shorter tower with a larger diameter by separation of the sections with a dividing wall rather than stacking them on top of one another.

### Renewable Fuel Production

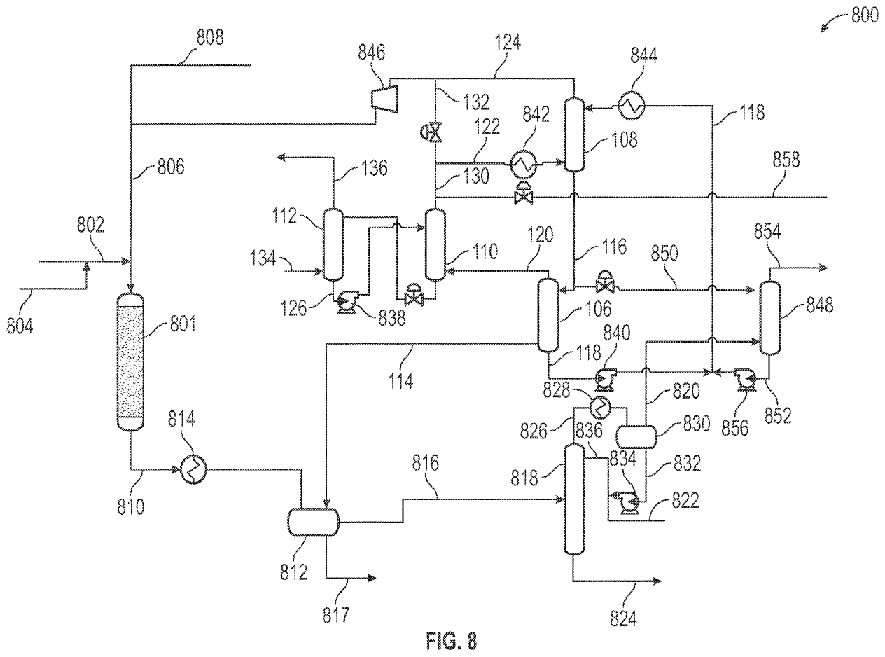

In accordance with one or more embodiments, the sulfur (H₂S) recovery is integrated into a system for renewable fuel production. FIG. 8 is an illustration of a fuel production system 800 for renewable fuel production with acid gas removal and H₂S recycle in accordance with one or more embodiments. As illustrated, the fuel production system 800 integrates recovery and recycle of sulfur with an H₂S absorber 106/H₂S de-sorber 108 and CO₂ absorber 110/CO₂ de-sorber 112 with a hydroprocessing reactor 801 that generates fuel range paraffins from a biofeedstock. While the techniques for sulfur recovery disclosed herein are suitable for use in the fuel production system 800 illustrated on FIG. 8, it should be understood that the acid gas removal techniques are not limited to the embodiments disclosed on FIG. 8 but can be utilized in other systems for fuel (or renewable fuel) production where recovery and recycle of sulfur would be beneficial.

In the illustrated embodiment, a biofeedstock stream 802 comprising a biofeedstock is fed into a hydroprocessing reactor 801 in accordance with one or more embodiments. As illustrated, a sulfiding agent 804 (e.g., DMDS) and/or a hydrogen stream 806 may be combined with the biofeedstock stream 802 and heated prior to introducing into the hydroprocessing reactor. Alternatively, the sulfiding agent 804 and/or the hydrogen stream 806 (or a portion of either stream) may be introduced directly into the hydroprocessing reactor 806. In some embodiments, the sulfiding agent 804 may be eliminated and/or reduced if there is sufficient sulfur recovery and recycle. Example embodiments further include make-up hydrogen gas 808 if needed for the hydroprocessing. As illustrated, the make-up hydrogen gas 808 may be added to the recycle stream 124 to form the hydrogen stream 806 fed into the hydroprocessing reactor 801.

In the hydroprocessing reactor 801, the biofeedstock is reacted with hydrogen to form, for example, fuel range paraffins. In accordance with example embodiments, the biofeedstock is exposed to hydroprocessing conditions in the hydroprocessing reactor 801 in the presence of one or more catalyst beds that contain a hydroprocessing catalyst such that the biofeedstock reacts with the hydrogen to reduce oxygen in the biofeedstock.

In the illustrated embodiments a hydrotreated effluent stream 810 including fuel range paraffins is withdrawn from the hydroprocessing reactor, cooled and flowed to a hydroprocessing separator 812, where a gas-phase portion is separated from liquid-phase products. In the illustrated embodiment, the hydrotreated effluent stream 810 is cooled in heat exchanger 814 prior to separation. In the illustrated embodiment, the hydroprocessing separator 812 produces a hydrotreated stream 816 including fuel range paraffins) and first gas stream 114. As will be discussed in more detail, H₂S and hydrogen in the first gas stream 114 can be recovered and recycled for reuse in the hydroprocessing reactor 801. The particular components in the hydrotreated stream 816 and first gas stream 114 will depend on number of factors, including the operating conditions of the hydroprocessing separator 812. In some embodiments, the hydroprocessing separator 812 operates at a temperature of 1° C. to 100° C. (e.g., 35° C. to 80° C., 45° C. to 75° C.) and a pressure of 1400 kPa to 10500 kPa (e.g., 4000 kPa to 5000 kPa). In some embodiments, the hydrocarbons in the hydrotreated stream 816 include long chain hydrocarbons (e.g., paraffins) from 6 carbons long to 24 carbons long or from 10 carbons long to 19 carbons long or from 15 carbons long to 19 carbons long. In some embodiments, the hydrotreated stream 816 also includes lighter hydrocarbons having 9 or few carbons, including methane, ethane, or propane, for example. A water stream 817 may also be separated in the hydroprocessing separator 812 in accordance with one or more embodiments. Stream 824 will be further isomerized to improve the cold flow properties. Hence, column 818 is also used to meet the required oxygenates specifications in the isomerization reactor.

In accordance with one or more embodiments, the hydrotreated stream 816 may be further processed. For example, at least a portion of the hydrocarbons in the hydrotreated stream 816 may be passed to an isomerization stage (not shown) for catalytic isomerization. Prior to the additional processing, the hydrotreated stream 816 may be processed, for example, to remove lighter hydrocarbons. In the illustrated embodiment, an interstage stripper 818 is used to remove lighter hydrocarbons from the hydrotreated stream 816. As illustrated, the interstage stripper 818 separates the hydrotreated stream 816 into a light ends stream 820, a naphtha stream 822, and a heavy paraffinic diesel stream 824. The light ends stream 820 may include hydrocarbons ranging from C₁ to C₄ carbons. The naphtha stream 822 may include hydrocarbons ranging from C₅ to C₁₁. The diesel stream 824 may include hydrocarbons ranging from C₁₂ to C₂₄, such as relatively high pour points, cloud points, or cold filter plugging points

In accordance with one or more embodiments, the diesel stream 824 is then catalytically isomerized, for example, to isomerize the long chain paraffins and thus, improve cold flow properties. However, it should be understood that the particular separation may be adjusted as desired to produce more or less streams as well as different hydrocarbon cuts in the streams.

In the illustrated embodiment, an overhead stream 826 is withdrawn from the interstage stripper 818, cooled by overhead heat exchanger 828, and passed to separator 830. The separator 830 separates the overhead stream 826 into light ends stream 820 and a condensed stream 832. The condensed stream 832 is pumped with reflux pump 834 with a portion of the condensed stream 832 returned to interstage stripper 818 as reflux stream 834 and another portion of the condensed stream 832 being withdrawn as naphtha stream 822.

For recovery and recycle of sulfur to the hydroprocessing reactor, the first gas stream 114 from the hydroprocessing separator 812 is passed to the H₂S absorber 106 in accordance with one or more embodiments. As previously described, the first gas stream 114 generally comprises hydrogen, CO₂, and H₂S. Additional components can be present in the first gas stream 114, including lighter hydrocarbons (e.g., C₁ to C₄ hydrocarbons), CO, and/or NH₃. In the illustrated embodiment, a first absorbent 116 is also fed to the H₂S absorber 106. In the H₂S absorber 106, the first gas stream 114 contacts at least the first absorbent 116 that selectively absorbs H₂S from the first gas stream 114 to produce at least an H₂S rich absorbent stream 118 and a second gas stream 120.

In the illustrated embodiment, the H₂S rich absorbent stream 118 is pumped by way of first absorbent pump 840 to the H₂S de-sorber 108. The H₂S de-sorber 108 regenerates the H₂S rich absorbent stream 118 by recovery of the absorbed H₂S. In some embodiments, the H₂S rich absorbent stream 118 is contacted with a hydrogen stripping medium 122 in the H₂S desorber 108 to produce at least an H₂S lean first absorbent and a recycle stream 124 comprising hydrogen and stripped H₂S. Thus, the absorbed H₂S is transferred directly from the liquid absorbent into the stripping gas. The H₂S lean first absorbent can then be used, for example, as the first absorbent 116 to contact the first gas stream 114. As illustrated, the H₂S rich absorbent stream 118 and/or hydrogen stripping medium 122 may be heated in a hydrogen heat exchanger 842 and a first absorbent heat exchanger 844, respectively.

As previously, described, the recycle stream 124 comprising hydrogen and stripped H₂S can be recycled, for example, to the hydroprocessing reactor 801. In this manner, system 200 provides for the recovery and reuse of H₂S. In the illustrated embodiment, the recycle stream 124 is compressed with recycle compressor 846 and then sent to the hydroprocessing reactor 801. As illustrated, make-up hydrogen gas 808 may be added to the recycle stream 124 if needed for the hydroprocessing.

To recover additional sulfur, the fuel production system 800 further includes a second H₂S absorber 848. The second H₂S absorber 848 operates, for example, at a lower pressure than the H₂S absorber 106. In the illustrated embodiment, the second H₂S absorber 848 receives light ends stream light ends stream 820. As noted above, light ends stream 820 includes hydrocarbons with from 1 to 4 carbons. In addition, the light ends stream 820 can also include H₂S. In the illustrated embodiment, the second H₂S absorber 848 also receives a lean absorbent 850, for example a portion of the second absorbent 116 from the H₂S de-sorber 108. In the second H₂S absorber 848, the light ends stream 820 contacts at least the lean absorbent 850 that selectively absorbs H₂S from the light ends stream 820 to produce at least a rich absorbent 852 and a sweet light ends stream 854. The terms “rich” and “sweet” as used herein refer to concentration of H₂S with their respective inlet streams, for example, the rich absorbent 852 contains more H₂S than the lean absorbent 850 while the sweet light ends stream 854 contains less H₂S than the light ends stream 820. The sweet light ends stream 854 may include H₂S in an amount of 1 ppmw 100 ppmw. The sweet light ends stream 854 can be used for any suitable purpose, such as fuel or in steam methane reforming. The rich absorbent 852 may be pumped with rich absorbent pump 856 and added to the H₂S rich absorbent stream 118 sent to the H₂S de-sorber 108.

In the illustrated embodiment, the second gas stream 120 is fed to a CO₂ absorber 110 for recovery of hydrogen by removal of CO₂ to form a hydrogen gas stream 130. A second absorbent 126 is also fed to the CO₂ absorber 110. In the CO₂ absorber 110, the second gas stream 120 is contacted with at least the second absorbent 126 to absorb CO₂ from the second gas stream 120 to produce at least a CO₂ rich absorbent stream 128 and a hydrogen gas stream 130. At least a portion of the hydrogen gas stream 130 is used as the hydrogen stripping medium 122 in the H₂S de-sorber 108 in accordance with one or more embodiments. As illustrated, a portion of the hydrogen gas stream 130 is directed to the H₂S de-sorber 108 for use as the hydrogen stripping medium 122. As illustrated, another portion of the hydrogen gas stream 130 may be removed as a gas purge 858. In some embodiments, the remaining portion 132 of the hydrogen gas stream 130 is added to the recycle stream 124 from the H₂S de-sorber 108.

In the illustrated embodiment, the CO₂ rich absorbent stream 128 is passed to the CO₂ de-sorber 112 for regeneration by recovery of the absorbed CO₂. In some embodiments, the CO₂ rich absorbent stream 128 is stripped with steam 134, or another suitable medium, such as a heat transfer fluid or hot gas (e.g., hot hydrogen gas). For example, the CO₂ rich absorbent stream 128 is contacted by the steam 134 in the CO₂ de-sorber 112 to produce at least a CO₂ lean second absorbent and a CO₂ stream 136 comprising the steam and stripped CO₂. Steam 134 is a stripping steam, for example, product by any means, for example, using a reboiler with steam or other process stream. The CO₂ lean second absorbent can then be used, for example, as the second absorbent 126 to contact the second gas stream 120. For example, the second absorbent 126 is pumped to the CO₂ absorber 110 by way of second absorbent pump 838. In some embodiments, the CO₂ stream 136 can sent to disposal or sequestration after drying or proper treatment to meet the required specifications.

### Biofeedstock

In accordance with present embodiments, a biofeedstock is processed to produce a renewable fuel. As used herein, a biofeedstock refers to a feed derived from a biological source, which is a feed derived from a biological raw material component, such as vegetable fats/oils or animal fats/oils, fish oils, pyrolysis oils, and algae lipids/oils, as well as components of such materials, and in some embodiments can specifically include one or more type of lipid compounds. Lipid compounds are typically biological compounds that are insoluble in water, but soluble in nonpolar (or fat) solvents. Non-limiting examples of such solvents include alcohols, ethers, chloroform, alkyl acetates, benzene, and combinations thereof.

Examples of vegetable oils that can be used in accordance with this invention include, but are not limited to, rapeseed (canola) oil, soybean oil, coconut oil, sunflower oil, palm oil, palm kernel oil, peanut oil, linseed oil, tall oil, corn oil, castor oil, jatropha oil, jojoba oil, olive oil, flaxseed oil, camelina oil, safflower oil, babassu oil, tallow oil and rice bran oil.

As an example, in some embodiments, renewable fuel production can correspond to conversion of a biofeedstock including a substantial portion of vegetable oil into renewable fuel, such as renewable jet and/or renewable diesel. Such a biofeedstock can include 40 wt. % or more of a bio-oil, or 60 wt. % or more, or 80 wt. % or more, such as up to being substantially composed of a bio-oil (99 wt. % or more). Some types of bio-oil can correspond to soybean oil, canola oil, and/or other types of oils corresponding to a primary bio-oil product. In such aspects, the bio-oil can optionally have a triglyceride content of 40 wt. % or more, or 60 wt. % or more, or 80 wt. % or more, such as up to being substantially composed of triglycerides. Other types of bio-oils can correspond to oils such as the corn oil that is formed as a secondary product during ethanol production from corn biomass.

Algae oils or lipids can typically be contained in algae in the form of membrane components, storage products, and/or metabolites. Certain algal strains, particularly microalgae such as diatoms and cyanobacteria, can contain proportionally high levels of lipids. Algal sources for the algae oils can contain varying amounts, e.g., from 2 wt. % to 40 wt. % of lipids, based on total weight of the biomass itself.

Vegetable fats/oils, animal fats/oils, fish oils, pyrolysis oils, and/or algae lipids/oils as referred to herein can also include processed material. Non-limiting examples of processed vegetable, animal (including fish), and algae material include fatty acids and fatty acid alkyl esters. Alkyl esters typically include C₁-C₅ alkyl esters of fatty acids. One or more of methyl, ethyl, and propyl esters are preferred.

Other bio-derived feeds usable in the present invention can include any of those which include primarily triglycerides and free fatty acids (FFAs). The triglycerides and FFAs typically contain aliphatic hydrocarbon chains in their structure having from 8 to 36 carbons, preferably from 10 to 26 carbons, for example from 10 to 22 carbons or 14 to 22 carbons. Types of triglycerides can be determined according to their fatty acid constituents. The fatty acid constituents can be readily determined using Gas Chromatography (GC) analysis. This analysis involves extracting the fat or oil, saponifying (hydrolyzing) the fat or oil, preparing an alkyl (e.g., methyl) ester of the saponified fat or oil, and determining the type of (methyl) ester using GC analysis. In one embodiment, a majority (i.e., greater than 50%) of the triglyceride present in the lipid material can be included of C₁₀ to C₂₆ fatty acid constituents, based on total triglyceride present in the lipid material. Further, a triglyceride is a molecule having a structure corresponding to a reaction product of glycerol and three fatty acids. Although a triglyceride is described herein as having side chains corresponding to fatty acids, it should be understood that the fatty acid component does not necessarily contain a carboxylic acid hydrogen. Other types of feed that are derived from biological raw material components can include fatty acid esters, such as fatty acid alkyl esters (e.g., FAME and/or FAEE).

In some embodiments, a portion of a mineral feedstock can be co-processed with a feed derived from a biological source. A mineral feedstock refers to a conventional feedstock, typically derived from crude oil and that has optionally been subjected to one or more separation and/or other refining processes. In one preferred embodiment, the mineral feedstock can be a petroleum feedstock boiling in the diesel range or above. Examples of suitable feedstocks can include, but are not limited to, virgin distillates, hydrotreated virgin distillates, kerosene, diesel boiling range feeds (such as hydrotreated diesel boiling range feeds), light cycle oils, atmospheric gas oils, and the like, and combinations thereof. The amount of mineral feedstock blended with a feed derived from a biological source can correspond to 1.0 wt. % to 50 wt. % of the weight of the blended feedstock. Alternatively, the amount of feed derived from biological source can correspond to 1.0 wt. % to 50 wt. % of the weight of the blended feed stock. Additionally or alternately, in some embodiments, the amount of mineral feedstock blended with the bio-derived feed is low enough so that the resulting blended or combined feed has a sulfur content of 10 wppm to 1000 wppm.

Mineral feedstocks for blending with a bio-derived can be relatively free of nitrogen (such as a previously hydrotreated feedstock) or can have a nitrogen content from 1 wppm to 2000 wppm nitrogen, for example from 50 wppm to 1500 wppm or from 75 to 1000 wppm. In some embodiments, the mineral feedstock can have a sulfur content from 1 wppm to 10,000 wppm sulfur, for example from 10 wppm to 5,000 wppm or from 100 wppm to 2,500 wppm. However, in various aspects, such mineral feedstocks can be combined with a bio-derived feed (and/or other feeds) so that the resulting combined feed has a sulfur content of 1000 wppm or less, 300 wppm or less, or 200 wppm or less, or 100 wppm or less, such as down to 0.1 wppm or possibly still lower. Additionally or alternately, the combined feed can have an oxygen content of 1.0 wt. % or more, such as 1.0 wt. % to 15 wt. %.

### Hydroprocessing Stage

In accordance with present embodiments, a biofeedstock is exposed to hydroprocessing conditions in a hydroprocessing stage. A hydroprocessing stage can include one or more hydroprocessing reactors, with each hydroprocessing reactor including one or more catalyst beds. The catalyst beds within a reactor can include similar catalysts or different catalysts, depending on the configuration. Exposing a biofeedstock to hydroprocessing conditions can result in hydrodeoxygenation of the feed. In some embodiments, the hydrodeoxygenation includes reacting the biofeedstock with hydrogen to remove oxygen. The reaction in the HDO stage should produce a hydrotreated effluent that includes paraffin products, reaction intermediates, and unreacted biofeedstock and hydrogen. Example reaction intermediates include esters, acids, and ketones, alcohols, among others.

Some examples of hydroprocessing catalysts can correspond to hydrotreating catalysts. Examples of suitable hydroprocessing catalysts include at least one Group 6 metal and/or Group 8 metal, optionally on a support such as alumina or silica. Specific examples can include, but are not limited to, NiMo, CoMo, and NiW supported catalysts. In some embodiments, a catalyst can be used that includes a Group 6 metal on a support material, but less than 1.0 wt. % of a Group 8 metal. In other aspects, a hydrotreating catalysts that include both a Group 6 metal and a Group 8 metal on a support material can be used. At least one Group 6 metal, in oxide form, can typically be present in an amount ranging from 2.0 wt. % to 40 wt. %, relative to a total weight of the catalyst, or 6.0 wt. % to 40 wt. %, or 10 wt. % to 30 wt. %. When a Group 8-10 metal is also present, the at least one Group 8-10 metal, in oxide form, can typically be present in an amount ranging from 2.0 wt. % to 40 wt. %, preferably for supported catalysts from 2.0 wt. % to 20 wt. % or from 4.0 wt. % to 15 wt. %.

The hydroprocessing catalyst can be provided in a reactor in one or more catalyst beds. For example, a convenient bed length in some reactors is a bed length of 25 feet to 30 feet. Such a bed length reduces difficulties in a catalyst bed associated with poor flow patterns. Due to the heat release from the initial bed during olefin saturation and deoxygenation, some embodiments use a shorter catalyst bed as the initial bed, such as having a bed length of 10 feet to 25 feet.

The hydroprocessing reactor can be operated at any suitable conditions that are effective for hydrodeoxygenation. Effective hydrodeoxygenation conditions include, but are not limited to, a temperature of 230° C. or higher, for example, 285° C. or higher, 315° C. or higher, or 340° C. or higher. Additionally, or alternately, the temperature can be 400° C. or less, for example, 370° C. or less, or 340° C. or less. Suitable effective temperatures can be from 230° C. to 375° C., or 250° C. to 350° C. Effective hydrotreatment conditions can additionally or alternately include, but are not limited to, a total pressure of 1.4 MPag or more, for example, 3 MPag or more, 5 MPag or more, or 7 MPag or more. Additionally or alternately, the total pressure can be 10 MPag or less, for example 8 MPag or less, 7 MPag or less, or 6 MPag or less. In some embodiments, the hydrodeoxygenation conditions can include, but are not necessarily limited to, a temperature of 315° C. to 425° C. and a total pressure of 2 MPag to 21 MPag).

Additional hydroprocessing conditions for the hydroprocessing reactor include a hydrogen treat gas rate and a liquid hourly space velocity (LSHV). The LHSV can be from 0.1 hr⁻¹ to 10 hr⁻¹, or from 0.2 hr⁻¹ to 5.0 hr⁻¹. The hydrogen treat gas rate can be any convenient value that provides sufficient hydrogen for deoxygenation of a feedstock. Typical values can range from 500 scf/B (84 Nm³/m³) to 10,000 scf/B (1685 Nm³/m³). One option for selecting a treat gas rate can be to select a rate based on the expected stoichiometric amount of hydrogen for complete deoxygenation and olefin saturation of the feedstock. For example, many types of feeds derived from biological sources have a stoichiometric hydrogen need for deoxygenation of between 200 scf/B (34 Nm³/m³) to 5000 scf/B (˜850 Nm³/m³). In some embodiments, the hydrogen treat gas rate can be selected based on a multiple of the stoichiometric hydrogen need, such as at least 1 times the hydrogen need, or at least 1.5 times the hydrogen need, or at least 2 times the hydrogen need, such as up to 10 times the hydrogen need or possibly still higher. In other aspects where at least a portion of the gas phase deoxygenation effluent is recycled, any convenient amount of hydrogen relative to the stoichiometric need can be used. In various aspects, the hydrogen treat gas can be an H₂S-enriched hydrogen treat gas as described herein with an H₂S content of 5 ppmv to 3.0 vol %.

As previously described, the hydroprocessing stage should at least partially deoxygenate the biofeedstock. Deoxygenating the biofeedstock can avoid problems with catalyst poisoning or deactivation due to the creation of water or carbon oxides during the subsequent isomerization stage. The hydroprocessing stage can be used to substantially deoxygenate the biofeedstock. This corresponds to removing 90% or more, for example, 95% or more, 98% or more, 99% or more, 99.5% or more, 99.9% or more, or completely (measurably) all the oxygen present in the biofeedstock. Alternately, substantially deoxygenating the biofeedstock can correspond to reducing the oxygenate level of the hydrotreated biofeedstock to 0.1 wt. % or less, for example, 0.05 wt. % or less, 0.03 wt. % or less, 0.02 wt. % or less, 0.01 wt. % or less, 0.005 wt. % or less, 0.003 wt. % or less, 0.002 wt. % or less, or 0.001 wt. % or less.

### ADDITIONAL EMBODIMENTS

Accordingly, the present disclosure may provide techniques for acid gas removal and H₂S recycling that reduce consumption of sulfiding agents in hydroprocessing. The methods and systems may include any of the various features disclosed herein, including one or more of the following embodiments.

Embodiment 1. A method comprising: contacting a first gas stream with at least a first absorbent, wherein the first gas stream comprises hydrogen, CO₂, and hydrogen sulfide, wherein the first absorbent provides selectivity of greater than 4 to produce at least an H₂S rich absorbent stream and a second gas stream; contacting the H₂S rich absorbent stream with at least a first stripping medium comprising hydrogen in an amount of 70 mole % to 99 mole %, wherein the first stripping medium strips 90 mole % to 99.9 mole % of absorbed hydrogen sulfide from the H₂S rich absorbent stream to produce at least an H₂S lean first absorbent and a recycle stream comprising the first stripping medium and stripped H₂S; contacting the second gas stream with at least a second absorbent to absorb at least a portion of the CO₂ from the second gas stream to produce at least a hydrogen gas stream and a CO₂ rich second absorbent; and contacting the CO₂ rich second absorbent with at least a second stripping medium to produce at least a CO₂ lean second absorbent and a CO₂ stream.

Embodiment 2. The method of Embodiment 1, wherein the hydrogen is present in the first gas stream in an amount of about 70 mole % to about 99 mole %, the CO₂ is present in the first gas stream in an amount of about 0.1 mole % to about 5 mole %, and the hydrogen sulfide is present in the first gas stream in an amount of about 5 ppmv to about 2000 ppmv.

Embodiment 3. The method of Embodiment 1 or Embodiment 2, wherein the contacting uses a spray column, a countercurrent trayed column, or a co-current contactor.

Embodiment 4. The method of any preceding Embodiment, wherein the contacting comprises flowing the first absorbent through a droplet generator to generate droplets of the first absorbent dispersed in the first gas stream then flowing a combined stream of the droplets and the first gas stream through a cyclonic separator to remove the droplets from the first gas stream generating the second gas stream, wherein the droplets are collected in a collector from which the H₂S rich absorbent stream is removed.

Embodiment 5. The method of any preceding Embodiment, wherein the first absorbent comprises at least one selective absorbent selected from the group consisting of a tertiary amine, sterically hindered amine, and a combination thereof.

Embodiment 6. The method of any preceding Embodiment, wherein the first absorbent further comprises an organic co-solvent.

Embodiment 7. The method of any preceding Embodiment, wherein the first absorbent comprises a sterically hindered amine with an amino group that is attached to at least one secondary or tertiary carbon that is a link to an alkyl or alkoxy functional group, wherein the alkyl or alkoxy function group is methyl capped or uncapped with a terminal hydroxyl group.

Embodiment 8. The method of any one of Embodiments 1 to 6, wherein the first absorbent comprises at least one tertiary or sterically hindered amine selected from the group consisting f methyldiethanolamine (MDEA), ethoxyethanol-t-butylamine (EETB), methoxyethoxyethoxyethanol-t-butylamine (MEEETB), and combinations thereof.

Embodiment 9. The method of any one of Embodiments 1 to 6, wherein the first absorbent comprises a sterically hindered amine of Formula 1 above.

Embodiment 10. The method of any one of Embodiments 1 to 6, wherein the first absorbent comprises a sterically hindered amine of Formula 2 above.

Embodiment 11. The method of any one of Embodiments 1 to 6, wherein the first absorbent comprises a sterically hindered amine of Formula 3 above.

Embodiment 12. The method of any preceding Embodiment, wherein at least a portion of the lean H₂S first absorbent is used as the first absorbent.

Embodiment 13. The method of any preceding Embodiment, wherein the first absorbent has a selectivity to H₂S of 4 to 15.

Embodiment 14. The method of any preceding Embodiment, wherein at least a portion of the hydrogen gas stream is used as the stripping medium.

Embodiment 15. The method of any preceding Embodiment, wherein the second absorbent comprises at least one absorbent selected from the group consisting of a primary alkanolamine, a secondary alkanolamine, a sterically hindered amine, and combinations thereof.

Embodiment 16. The method of any preceding Embodiment, wherein the recycle stream has a CO₂ concentration of 100 ppmv or less and an H₂S concentration of 100 ppmv to 1,000 ppmv.

Embodiment 17. The method of Embodiment 1, further comprising recycling at least a portion of the recycle stream to a hydroprocessing reactor, wherein a biofeedstock and the recycle stream are exposed to a hydroprocessing catalyst to produce a hydrotreated effluent.

Embodiment 18. The method of Embodiment 17, further comprising separating the hydrotreated effluent into the first gas stream, a hydrotreated effluent comprising fuel range paraffins, and water.

Embodiment 19. A method comprising: reacting at least a biofeedstock and hydrogen in a hydroprocessing reactor to product at least a hydrotreated effluent; separating the hydrotreated effluent into a first gas stream and a hydrotreated effluent comprising fuel range paraffins and water; contacting the first gas stream with at least a first absorbent, wherein the first gas stream comprises hydrogen, CO₂, and hydrogen sulfide, wherein the first absorbent has a selectivity to H₂S of 4 to 15; contacting the second gas stream with at least a second absorbent to absorb at least a portion of the CO₂ from the second gas stream to produce at least a hydrogen gas stream and a CO₂ rich second absorbent; contacting the CO₂ rich second absorbent with at least a second stripping medium to produce at least a CO₂ lean second absorbent and a CO₂ stream; contacting the H₂S rich absorbent stream with at least a portion of the hydrogen gas stream, wherein the first stripping medium strips at least 90 mole % to 99.9 mole % of absorbed hydrogen sulfide from the H₂S rich absorbent stream to produce at least an H₂S lean first absorbent and a recycle stream comprising the first stripping medium and stripped H₂S; and recycling at least a portion of the recycle stream to the hydroprocessing reactor.

Embodiment 20. The method of Embodiment 19, wherein the recycle stream has a CO₂ concentration of 100 ppmv or less and an H₂S concentration of 100 ppmv to 1,000 ppmv.

To facilitate a better understanding of the present invention, the following examples of certain aspects of some embodiments are given. In no way should the following examples be read to limit, or define, the entire scope of the disclosure.

### EXAMPLES

This example was performed to compare techniques of acid gas absorption that use an H₂S selective absorbent with conventional processes. The processes were simulated using a proprietary property package developed from experimental data. Test 1 simulated a refinery configuration with non-selective absorbent with near complete H₂S and CO₂ removal, followed by selective removal of H₂S in an acid gas enrichment (AGE) unit. The concentrated acid gas comprised of 30 vol % H₂S is sent to a sulfur recovery unit. Test 2 simulated the same acid gas removal unit as Test 1 except that the enriched acid gas is compressed and recycled back to the hydroprocessing reactor versus the sulfur recovery unit. Test 3 simulated the system 100 from FIG. 1 with selective H₂S removal followed by CO₂ removal. Tests 1 and 2 each resulted in a hydrogen recycle that was sweet. Test 1 has no recycling of H₂S. Test 2 resulted in an enriched H₂S gas for recycle. Test 3 resulted in a hydrogen recycle that also includes the recovered H₂S. For each of Tests 1, 2, and 3, the feed gas from the reactor had a flow rate of 90 million standard cubic feet per day (MMSCFD) (2,365,000 Nm³/day) and included 200 ppmv of H₂S and 3300 ppmv of CO₂. The feed gas was from a hydroprocessing reactor that used dimethyl disulfide (DMDS) as a sulfiding agent.

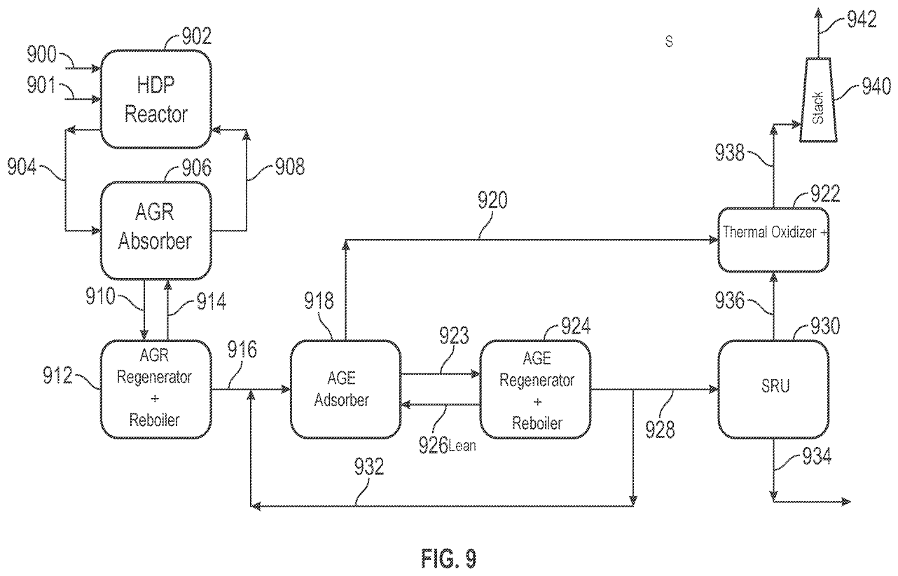

Test 1 (comparative): The configuration for Test 1 is shown on FIG. 9. A biofeed 900 of canola oil is fed at a rate of 10,000 barrels per day (1,590 m³/day) to a hydroprocessing reactor 902 together with 4464 lb/day (2024 lb/day) of DMDS 901. From the hydroprocessing reactor 902, a feed gas 904 containing 200 ppmv of H₂S and 3300 ppmv of CO₂ is fed to an acid gas removal (AGR) absorber 906 at a rate of 90 MMSCFD (2,365,000 Nm³/day). The AGR absorber 906 removes both H₂S and CO₂. From the AGR absorber 906, an H₂ recycle 908 containing <1 ppmv of H₂S and <10 ppmv of CO₂ is returned to the hydroprocessing reactor 902. The absorbent used in the AGR absorber 906 is 20 wt % MEA. A rich MEA 910 from the AGR absorber 906 is sent to an AGR regenerator plus reboiler 912 with lean MEA 914 is sent back to the AGR absorber 906 at a rate of 70 gpm (265 liters per minute (1 μm)). From the AGR regenerator plus reboiler 912, an acid gas 916 is sent to an acid gas enrichment (AGE) absorber for CO₂ removal with a sterically hindered amine. Rejected CO₂ 920 containing 79 ppmv of H₂S and 89 mol % CO₂ is sent to a thermal oxidizer 922. A rich amine 923 from the AGE absorber 918 is sent to an AGE regenerator plus reboiler 924 with lean amine 926 is sent back to the AGE absorber at a rate of 26 gpm (98.4 liters per minute). From the AGE regenerator plus reboiler 924, an enriched acid gas 928 containing >30 mol % H₂S is sent to a sulfur recovery unit 930. The sulfur recovery unit 930 produces element sulfur 934 in an amount of 17 MT/d with an off gas stream 936 sent to the thermal oxidizer 922. Waste gas 938 from the thermal oxidizer 922 is sent to a stack 940 for release of a flue gas 942 containing CO₂ and SO₂.

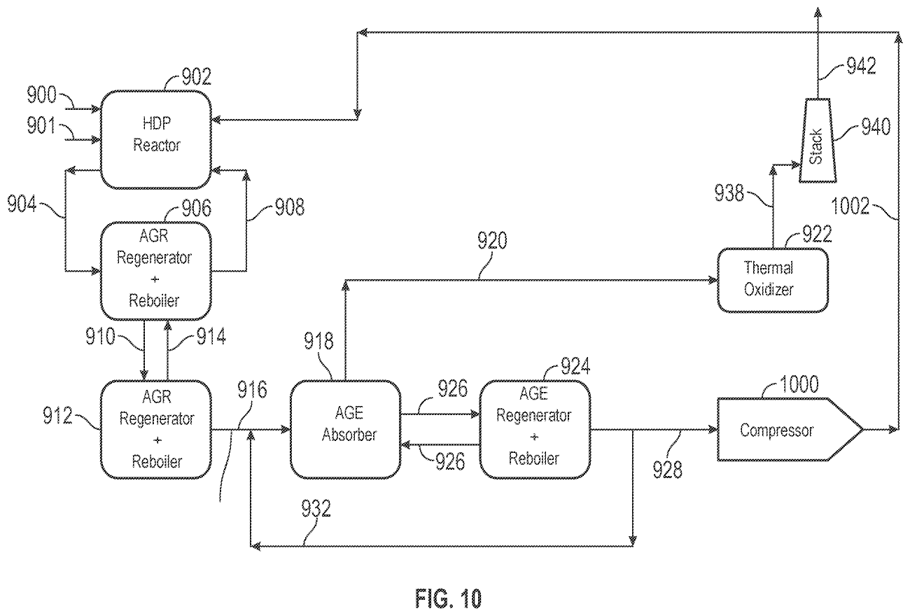

Test 2 (comparative): The configuration for Test 2 is shown on FIG. 10. This configuration is similar to Test 1 except the enriched acid gas 928 is sent to a compressor 1000 with an acid gas recycle 1002 provided from the compressor to the hydroprocessing reactor 902. Because sulfur is provided in the acid gas recycle 1002, the consumption of the DMDS is reduced in Test 2 to 6 lb/day (2.7 kg/day).

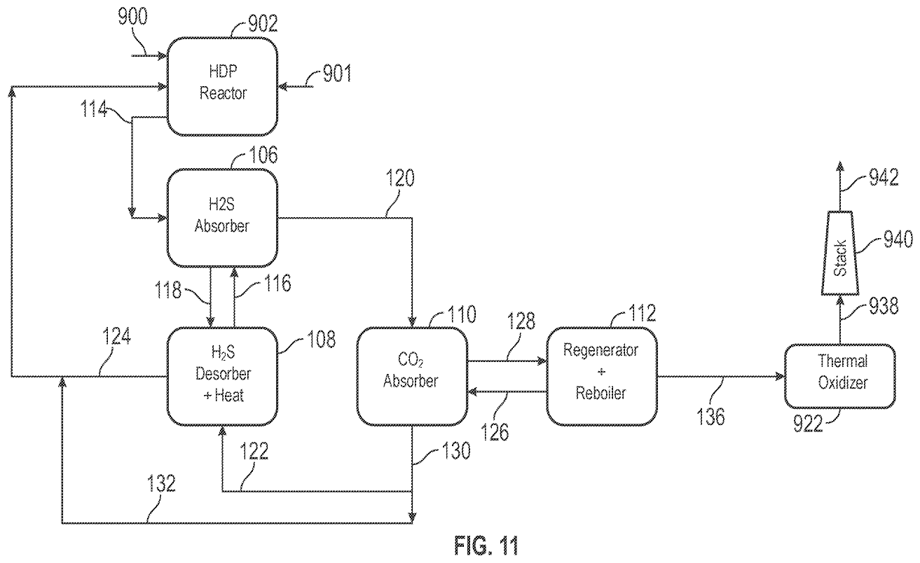

Test 3: The configuration for Test 3 is shown on FIG. 11. This configuration is similar to the configuration shown on FIG. 1. A biofeed of canola oil is fed at a rate of 10,000 barrels per day (1,590 m³/day) to a hydroprocessing reactor 902 together with 6 lb/day (2.7 kg/day) of DMDS 901. From the hydroprocessing reactor 902, a first gas stream 114 containing 200 ppmv of H₂S and 3300 ppmv of CO₂ is fed to an H₂S absorber 106 at a rate of 90 MMSCFD (2,365,000 Nm³/day). The H₂S absorber 106 selectively removes H₂S using a sterically hindered amine. In the H₂S absorber 106, the first gas stream 114 is contacted with at least a first absorbent 116 to selectively absorb hydrogen sulfide from the first gas stream 114 to produce at least an H₂S rich absorbent stream 118 and a second gas stream 120. The H₂S rich absorbent stream 118 is regenerated in H₂S desorber 108. In the H₂S desorber 108, the H₂S rich absorbent stream 118 is contacted with a hydrogen stripping medium 122 to produce at least an H₂S lean first absorbent (e.g., a first absorbent 116) and a recycle stream 124 comprising hydrogen and stripped H₂S. The first absorbent 116 is returned to the H₂S absorber 106 at a rate of 15 gpm (56.8 lpm). The recycle stream 124 containing 200 ppm of H₂S and 218 ppm of CO₂ is recycled to the hydroprocessing reactor 902. The second gas stream 120 is fed to a CO₂ absorber 110. In the CO₂ absorber 110, the second gas stream 120 is contacted with at least a second absorbent 126 comprising MEA to absorb CO₂ from the second gas stream 120 to produce at least a CO₂ rich absorbent stream 128 and a hydrogen gas stream 130. At least a portion of the hydrogen gas stream 130 is used as the hydrogen stripping medium 122 in the H₂S de-sorber 108 in accordance with one or more embodiments. The remaining portion 132 of the hydrogen gas stream 130 is added to the recycle stream 124 from the H₂S de-sorber 108. The CO₂ rich absorbent stream 128 is passed to the CO₂ de-sorber 112 for regeneration by recovery of the absorbed CO₂ and produce at least a CO₂ lean second absorbent and a CO₂ stream 136 comprising the steam and stripped CO₂. The CO₂ lean second absorbent is returned CO₂ absorber 110 at a rate of 70 gpm as the second absorbent 126. The CO₂ stream 136 from the CO₂ de-sorber 112 contains 91 mol % CO₂ and 87 ppmv of H₂S. The CO₂ stream 136 is sent to a thermal oxidizer 922 at a rate of 0.3 MMSCFD (7884 Nm³/day). Waste gas 938 from the thermal oxidizer 922 is sent to a stack 940 for release of a flue gas 942 containing CO₂ and SO₂.

The results of the simulations are provided in the table below:

TABLE 1

| | | | Test 2 | |
|---|---|---|---|---|
| | | | H₂S | Test3 |
| | | | Recovered | H₂S |
| | | Test 1 | via Recycle | Recovered |
| | | No H₂S | Enriched | via H₂ |
| | Stream No. | Recovery | Acid Gas | stripping |
| Feed Gas, | 114 or 904 | 90 | 90 | 90 |
| MMSCFD | | | | |
| H₂S, ppmv | 114 or 904 | 200 | 200 | 200 |
| CO₂, ppmv | 114 or 904 | 3300 | 3300 | 3300 |
| H₂S, lb/day | 114 or 904 | 1616 | 1616 | 1616 |
| CO₂, lb/day | 114 or 904 | 34,446 | 34,446 | 34,446 |
| H₂ to HDP, | 908 | 89.8 | 89.8 | — |
| MMSCFD | | | | |
| H₂S, ppmv | 908 | <1 | <1 | — |
| CO₂, ppmv | 908 | <10 | <10 | — |
| H₂S, lb/day | 908 | <1 | <1 | — |
| CO₂, lb/day | 908 | <20 | −<20 | — |
| H₂ to HDP, | 124 + 132 | — | — | 89.8 |
| MMSCFD | | | | |
| H₂S, ppmv | 124 + 132 | — | — | 200 |
| CO₂, ppmv | 124 + 132 | — | — | 218 |
| H₂S, lb/day | 124 + 132 | — | — | 1614 |
| CO₂, lb/day | 124 + 132 | — | — | 2260 |
| Acid Gas, | 928 | — | 0.06 | — |
| MMSCFD | | | | |
| H₂S, mol % | 928 | — | 30 | — |
| H₂S, lb/day | 928 | N/A | 1614 | N/A |
| CO₂, lb/day | 928 | N/A | 4450 | N/A |
| Total Gas to | | 0.3 | 0.3 | 0.3 |
| disposal, MMSCFD | | | | |
| H₂S, lb/day | | 1616 | 2 | 2 |
| CO₂, lb/day | | 34,440 | 29,990 | 32,170 |
| H₂S Recovery, % | | — | 99.9 | 99.9 |
| DMDS, lb/day | 901 | 4464 | 6 | 6 |

Accordingly, as illustrated in the table above, Test 3 did not generate an enriched H₂S stream for recycle that can be dangerous to handle. Instead, Test 3 generated an H2 recycle with 200 ppmv of H₂S for recycle. In addition, Test 3 has a lower DMDS makeup requirement than Test 1 while having lower compression ratio than Test 2.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated

1. A method comprising:
contacting a first gas stream with at least a first absorbent, wherein the first gas stream comprises hydrogen, CO₂, and hydrogen sulfide, wherein the first absorbent provides a selectivity to H₂S of greater than 4 to produce at least an H₂S rich absorbent stream and a second gas stream;
contacting the H₂S rich absorbent stream with at least a first stripping medium comprising hydrogen in an amount of 70 mole % to 99 mole %, wherein the first stripping medium strips 90 mole % to 99.9 mole % of absorbed hydrogen sulfide from the H₂S rich absorbent stream to produce at least an H₂S lean first absorbent and a recycle stream comprising the first stripping medium and stripped H₂S;
contacting the second gas stream with at least a second absorbent to absorb at least a portion of the CO₂ from the second gas stream to produce at least a hydrogen gas stream and a CO₂ rich second absorbent; and
contacting the CO₂ rich second absorbent with at least a second stripping medium to produce at least a CO₂ lean second absorbent and a CO₂ stream.

2. The method of claim 1, wherein the hydrogen is present in the first gas stream in an amount of about 70 mole % to about 99 mole %, the CO₂ is present in the first gas stream in an amount of about 0.1 mole % to about 5 mole %, and the hydrogen sulfide is present in the first gas stream in an amount of about 5 ppmv to about 2000 ppmv.

3. The method of claim 1, wherein the contacting uses a spray column, a countercurrent trayed column, or a co-current contactor.

4. The method of claim 1, wherein the contacting comprises flowing the first absorbent through a droplet generator to generate droplets of the first absorbent dispersed in the first gas stream then flowing a combined stream of the droplets and the first gas stream through a cyclonic separator to remove the droplets from the first gas stream generating the second gas stream, wherein the droplets are collected in a collector from which the H₂S rich absorbent stream is removed.

5. The method of claim 1, wherein the first absorbent comprises at least one selective absorbent selected from the group consisting of a tertiary amine, sterically hindered amine, and a combination thereof.

6. The method of claim 1, wherein the first absorbent further comprises an organic co-solvent.

7. The method of claim 1, wherein the first absorbent comprises a sterically hindered amine with an amino group that is attached to at least one secondary or tertiary carbon that is a link to an alkyl or alkoxy functional group, wherein the alkyl or alkoxy function group is methyl capped or uncapped with a terminal hydroxyl group.

8. The method of claim 1, wherein the first absorbent comprises at least one tertiary or sterically hindered amine selected from the group consisting of methyldiethanolamine (MDEA), ethoxyethanol-t-butylamine (EETB), methoxyethoxyethoxyethanol-t-butylamine (MEEETB), and combinations thereof.

9. The method of claim 1, wherein the first absorbent comprises a sterically hindered amine of the following formula: 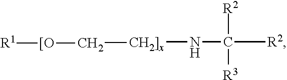
wherein R¹ is a C1-C5 alkyl or a C1-C5 alkyl alcohol, R² is a C1-C5 alkyl, R³ is hydrogen or a C1-C5 alkyl and x is an integer from 1 to 10.

10. The method of claim 1, wherein the first absorbent comprises a sterically hindered amine of the following formula: 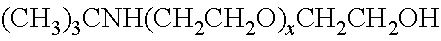
wherein x is an integer from 1 to 4.

11. The method of claim 1, wherein the first absorbent comprises a sterically hindered amine of the following formula: 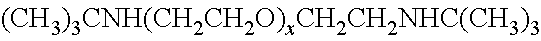
wherein x is an integer from 1 to 4.

12. The method of claim 1, wherein at least a portion of the lean H₂S first absorbent is used as the first absorbent.

13. The method of claim 1, wherein the first absorbent has a selectivity to H₂S of 4 to 15.

14. The method of claim 1, wherein at least a portion of the hydrogen gas stream is used as the stripping medium.

15. The method of claim 1, wherein the second absorbent comprises at least one absorbent selected from the group consisting of a primary alkanolamine, a secondary alkanolamine, a sterically hindered amine, and combinations thereof.

16. The method of claim 1, wherein the recycle stream has a CO₂ concentration of 100 ppmv or less and an H₂S concentration of 100 ppmv to 1,000 ppmv.

17. The method of claim 1, further comprising recycling at least a portion of the recycle stream to a hydroprocessing reactor, wherein a biofeedstock and the recycle stream are exposed to a hydroprocessing catalyst to produce a hydrotreated effluent.

18. The method of claim 17, further comprising separating the hydrotreated effluent into the first gas stream, a hydrotreated effluent comprising fuel range paraffins, and water.

19. A method comprising:
reacting at least a biofeedstock and hydrogen in a hydroprocessing reactor to product at least a hydrotreated effluent;
separating the hydrotreated effluent into a first gas stream and a hydrotreated effluent comprising fuel range paraffins and water;
contacting the first gas stream with at least a first absorbent, wherein the first gas stream comprises hydrogen, CO₂, and hydrogen sulfide, wherein the first absorbent has a selectivity to H₂S of 4 to 15;
contacting the second gas stream with at least a second absorbent to absorb at least a portion of the CO₂ from the second gas stream to produce at least a hydrogen gas stream and a CO₂ rich second absorbent;
contacting the CO₂ rich second absorbent with at least a second stripping medium to produce at least a CO₂ lean second absorbent and a CO₂ stream;
contacting the H₂S rich absorbent stream with at least a portion of the hydrogen gas stream, wherein the first stripping medium strips at least 90 mole % to 99.9 mole % of absorbed hydrogen sulfide from the H₂S rich absorbent stream to produce at least an H₂S lean first absorbent and a recycle stream comprising the first stripping medium and stripped H₂S; and
recycling at least a portion of the recycle stream to the hydroprocessing reactor.

20. The method of claim 19, wherein the recycle stream has a CO₂ concentration of 100 ppmv or less and an H₂S concentration of 100 ppmv to 1,000 ppmv.
